(19) United States
(12) Patent Application Publication
(10) Pub. No.: US 2009/0189972 A1
(43) Pub. Date: Jul. 30, 2009

(54) System and method for video medical examination and real time transmission to remote locations

(76) Inventors: Michael D. Harris, Scottsdale, AZ (US); Joel E. Barthelemy, Scottsdale, AZ (US)

Correspondence Address: TOD R NISSLE, PO BOX 55630, PHOENIX, AZ, 85078, US

(21) Appl. No.: 12/319,049

(22) Filed: Dec. 31, 2008

Related U.S. Application Data
(63) Continuation-in-part of application No. 11/485,117, filed on Jul. 11, 2006.
(60) Provisional application No. 61/018,172, filed on Dec. 31, 2007.
(60) Provisional application No. 61/018,419, filed on Dec. 31, 2007.
(60) Provisional application No. 60/698,657, filed on Jul. 12, 2005.

(51) Int. Cl. H04N 7/14

(52) U.S. Cl. 348/14.08; 348/E07.077

(57) ABSTRACT

A method to generate a video image of a patient at a first location and simultaneously transmit the video image to a video conferencing system at a second location remote from the first location.

This application claims the benefit of priority of U.S. Provisional Patent Application Ser. No. 61/018,419, filed Dec. 31, 2007 and of U.S. Provisional Patent Application Ser. No. 61/018,172, filed Dec. 31, 2007.

This application is a continuation-in-part of U.S. patent application Ser. No. 11/485,117, filed Jul. 11, 2006 which claims the benefit of priority of U.S. Provisional Patent Application Ser. No. 60/698,657, filed Jul. 12, 2005.

This invention relates to video systems.

In a further respect, the invention relates to medical video systems and digital video systems utilized to examine or treat a living thing.

In another respect, the invention relates to digital video systems that facilitate the simultaneous examination of an object by individuals at different locations.

In still a further respect, the invention relates to a camera that determines the distance of the camera from an object being examined with the camera and that accurately calculates the true size of the object, or of a portion of the object.

In still another respect, the invention relates to a medical digital video system that utilizes both ambient light and other different wavelengths of light separately or in combination to facilitate the examination of a portion of an individual's body.

In yet a further respect, the invention relates to a medical video camera that utilizes an illuminating light source, mounts a lens in a housing that is adjacent the light source and that can be axially adjusted to focus the camera, utilizes a sensor to receive and process light from the light source that is reflected off the portion of a body being examined and then passes through the lens into the camera, and prevents light from the light source from traveling directly from the light source intermediate the housing and sensor.

In yet another respect, the invention relates to a medical digital video camera that utilizes a body-contacting collar that can contour to a portion of an individual's body that is being examined, that facilitates maintaining the camera stationary at a fixed distance from the individual's body, and that can permit at least a portion of ambient light to pass through the collar to illuminate the individual's body.

Since the beginning of the transmission of pictures (Radiovision) over radio waves in the 1920's to the realization of NTSC Television in the 1940's, to the real-life dramas and movies broadcast in the 1950's and 60's, to finally the High Definition digital video of the new millennia, engineers have been trying to close the gap of brining real-time imaging (“life”) into our homes, our work, our research facilities, the operating room and soon, the doctor's office. The first successful transmission of forty-eight lines of video was made on May 19, 1922 by Charles Francis Jenkins from his laboratory in Washington D.C. Today, video is a standard that everyone takes for granted and is adapted into almost every market and industry we can think of.

In many sectors of the health care industry, providing health care practitioners at each patient-care location is difficult. Care is often required at remote locations that are not easily accessed by specialty health care providers. Even when such specialty providers can travel to a remote location to visit patients, expense and time limitations impact the quality of care provided to the patient. Gains in the quality of care of such patients, and even of patients resident in a hospital, could be achieved if video or still images of all or a part of a patient's body could be captured and stored, could be transmitted to and from remote locations, or could be transmitted simultaneously to several health care providers.

A variety of video conferencing approaches have been implemented to facilitate one-on-one communications and group discussions. The techniques typically offer only limited methods to annotate visible information and usually are only operated between similarly-equipped computers and hardware CODEC's that access a common service. Real-time collaboration is hampered by delay associated in analyzing and storing images, and little capability exists to review real-time video information.

Some existing video products available in the market are:

Product 1. The UDM-M200x. This is a plastic camera that uses a VGA sensor and a single focus lens system.

Product 2. The M3 medical otoscope. This product is provided by M3 Medical Corporation. This scope has an analog video stream output and a VGA digital output via USB. It is battery powered and can use an external lighting source. It does not have any focusing from near to far and only uses a single light source for close previewing.

Product 3. The Endogo camera manufactured by Envisionier Medical Technologies of Rockville, Md. This camera includes a 2.4″ LCD viewing screen and analog outputs. It records via MPEG4 to a SD-RAM drive and can be uploaded to a computer via an USB interface. It also can be adapted to other optical flexible or rigid endoscopes with lighting sources, but does not have a lighting source of its own. It is large, awkward to use, and expensive.

Product 4. The AMD-2500 produced by Scalar Corporation of Japan and marketed by Advanced Medical Devices. This is an analog VGA camera with a zoom lens. It can be hand-held or mounted. It has two available lenses, one for micro viewing and one for macro viewing. It sells for about $5,500.00 and does not have software interfacing capability. It is awkward to hold and makes inspection of smaller areas of the body difficult.

Scalar also markets handheld microscopes.

Microscopic and macroscopic inspection are other techniques associated with the health care industry and other areas.

The use of microscopic inspection and macroscopic inspection has been plagued with either poor contrast or lack of definition of the object being viewed. As lenses and lighting techniques have been improved greatly over the past 50 years and have helped with the clarity and contrast of the subject matter, so have many doctors and scientists relied on “staining” the subject matter with fluoresces and other chemistries that respond to specific light wave lengths. This technique has been shown to improve some microscopic inspection industries, but only with still photography. It is also irreversible.

In fact, present digital microscopy and spectroscopy image enhancement and staining are limited to applying a chemical stain to a given slide and then taking a separate picture under several different light sources. After each picture is taken, each has to be copied over the top of the others so that each can be realized within the final photograph. The process can take several hours to perform to get a result only to find that the wrong color of light or stain was used during the build.

Further, in conventional RGB to YUV conversion systems, an interpolation of the red, green and blue data in the original pixel data is made in order to project color values for pixels in the sensor array that are not sensitive to that color. From the red, green and blue interpolated data, lumina and chroma values are generated. However, these methods do not take into account the different filtering and resolution requirements for lumina and chroma data. Thus, these systems do not optimize the filtering or interpolation process based on the lumina and chroma data.

Accordingly, it is an object of the invention to provide improved video and other examination techniques to facilitate the care of patients and to facilitate other endeavors which utilize such techniques.

This and other, further and more specific objects and advantages of the invention will be apparent to those of skill in the art in view of the following disclosure, taken in conjunction with the drawings, in which:

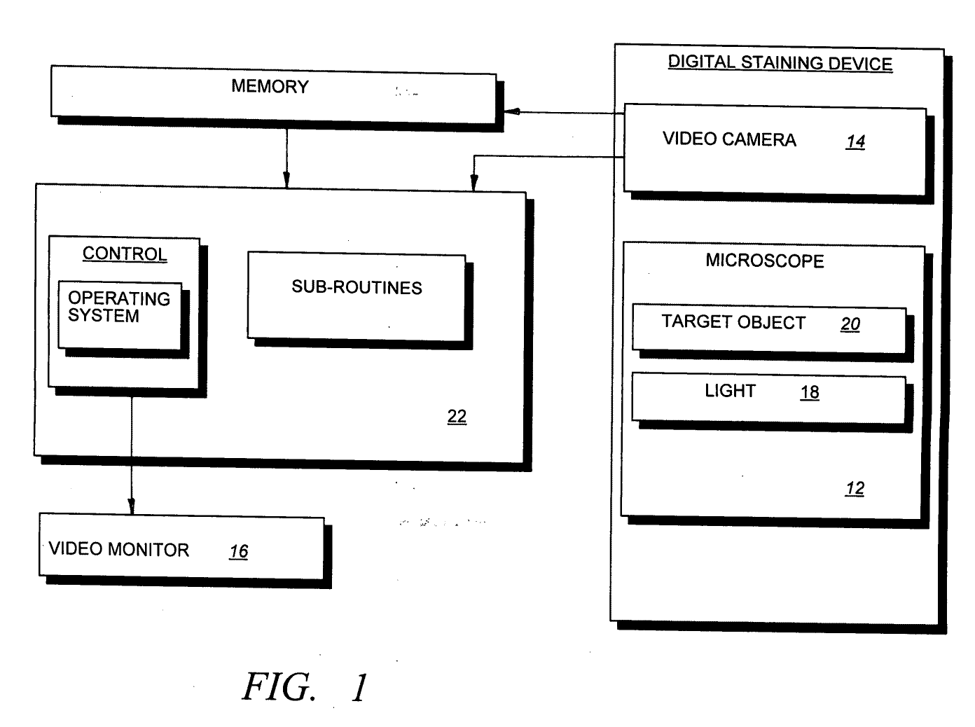

FIG. 1 is a perspective view illustrating a real-time image staining apparatus according to one embodiment of the present invention;

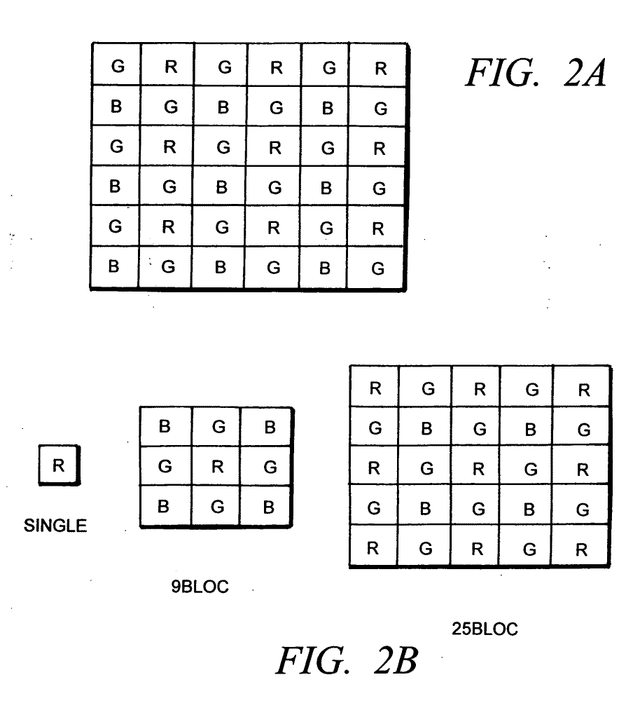

FIG. 2A is a diagram illustrating a sample RGB Bayer Pattern;

FIG. 2B is a diagram illustrating a single red pixel, a nine bloc of pixels, and a twenty five bloc of pixels;

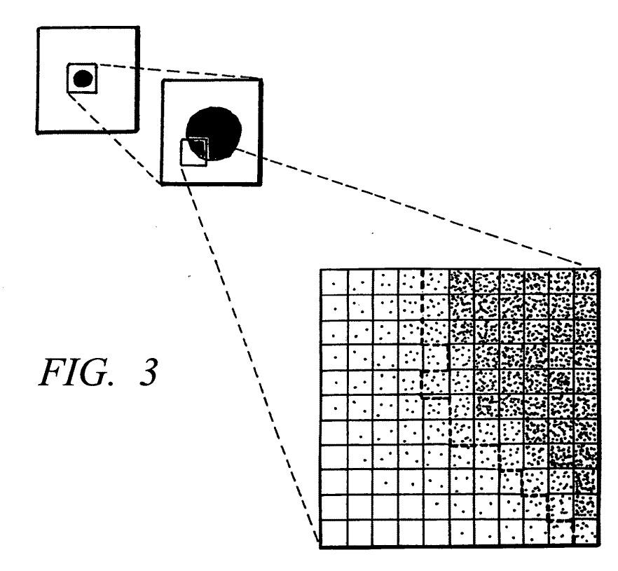

FIG. 3 is a diagram illustrating a sample Bayer Pattern of an edge color filter according to one embodiment of the present invention;

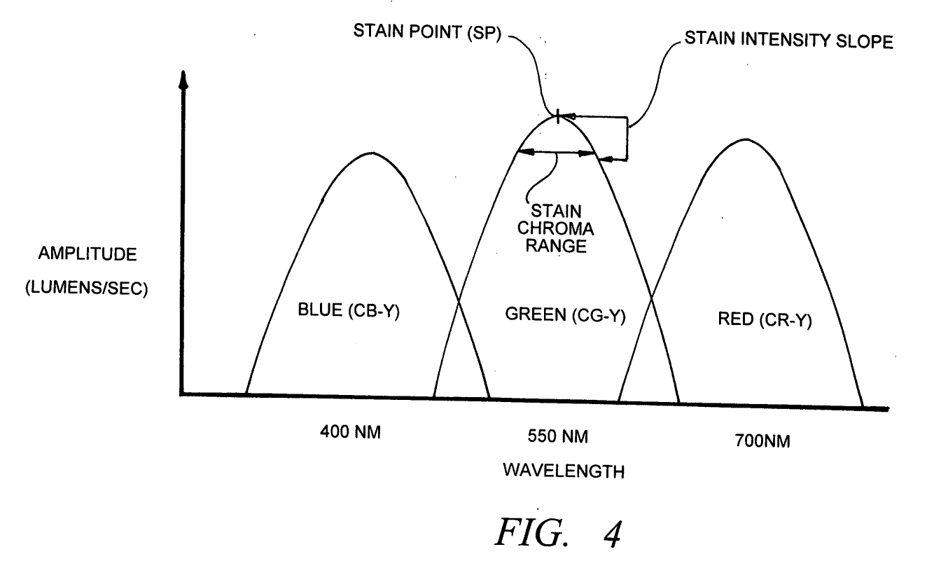

FIG. 4 is a graph illustrating the parametric stain point according to one embodiment of the present invention;

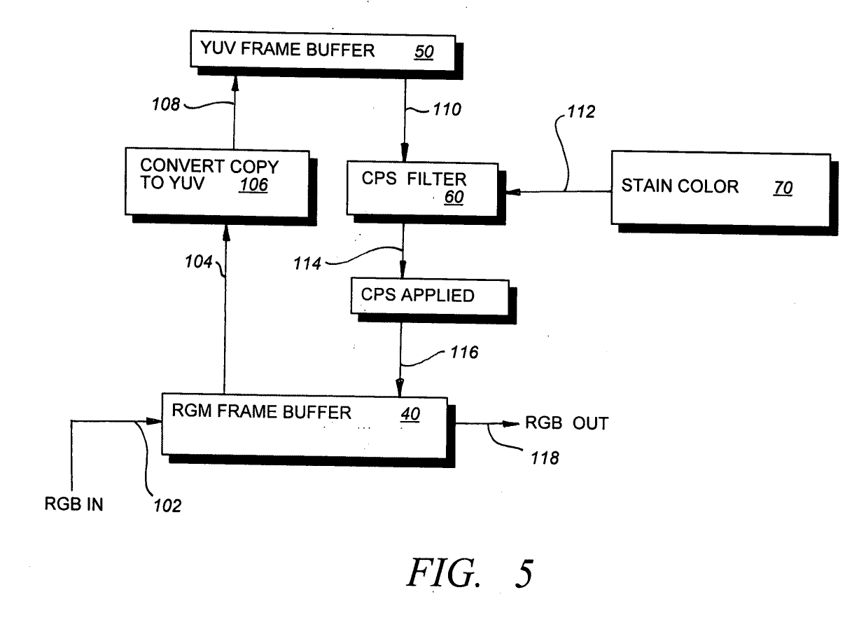

FIG. 5 is a flowchart illustrating the staining method according to one embodiment of the present invention;

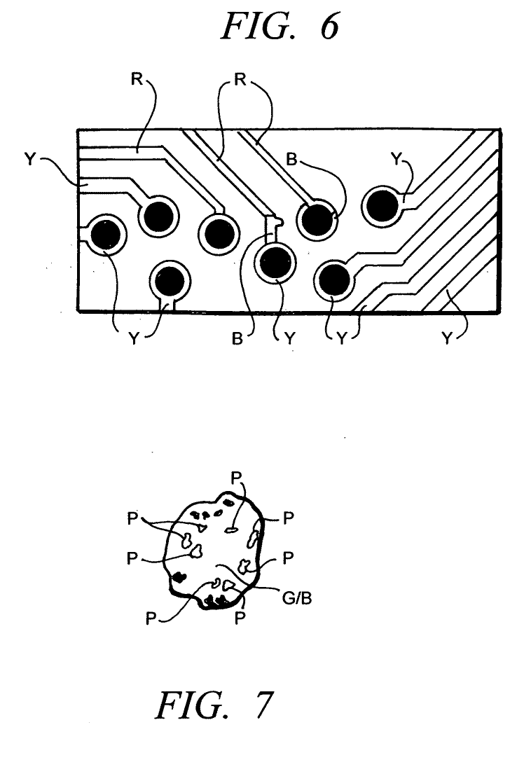

FIG. 6 is a diagram illustrating a tri-stain using the CPS technique in RGB color space of a Printed Circuit Board;

FIG. 7 is a diagram illustrating a live sample using the CPS technique in RGB color space, of a liver cell at a microscopic power of 100×;

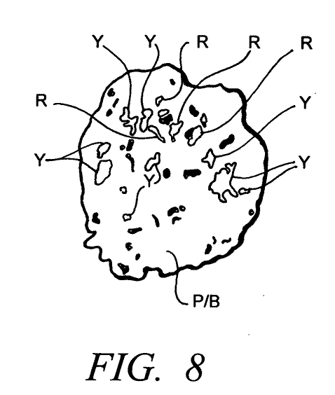

FIG. 8 is a diagram illustrating a regional stain isolating a region-of-interest within a pre-H/E stained tissue sample at a microscopic power of 250×;

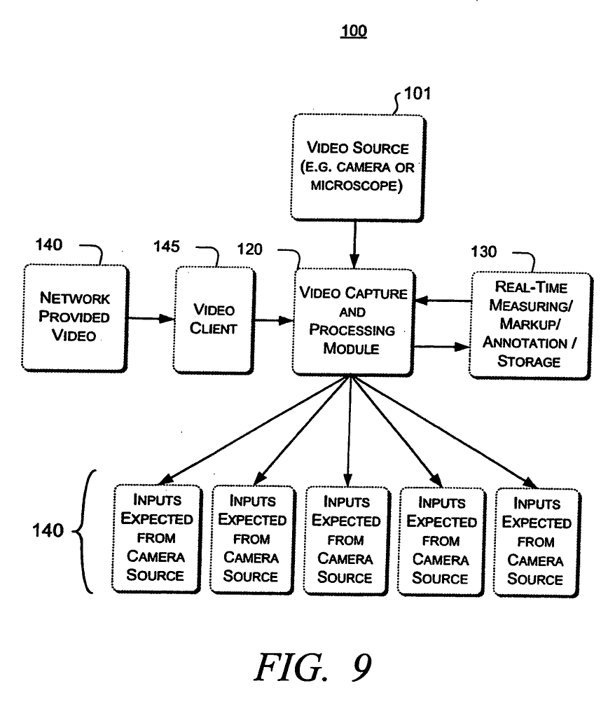

FIG. 9 is a block diagram illustrating a video conferencing system in accordance with one embodiment of the invention;

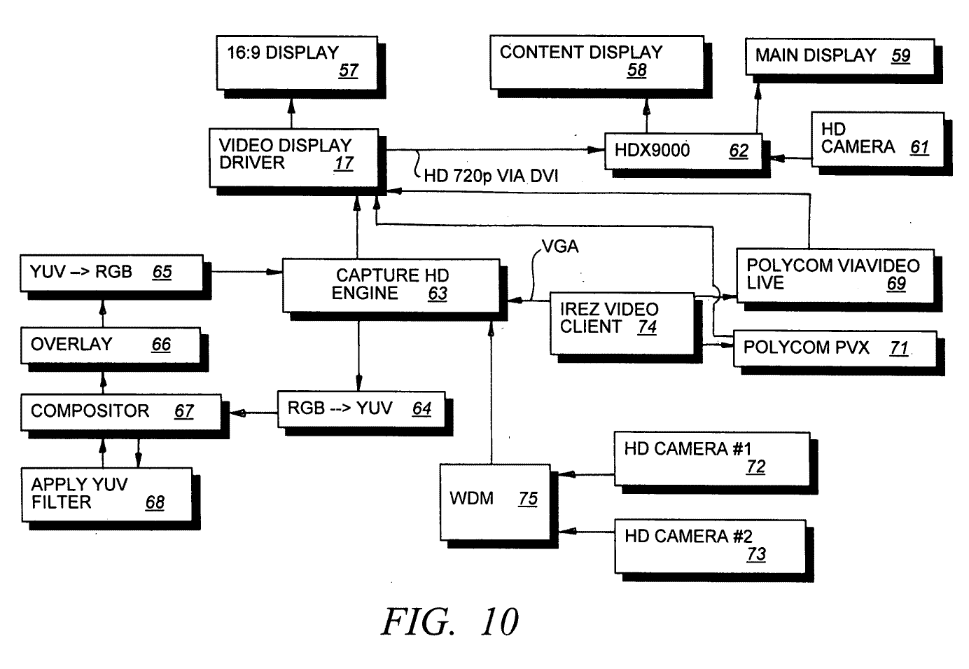

FIG. 10 is a block diagram illustrating an alternate video system in accordance with the invention;

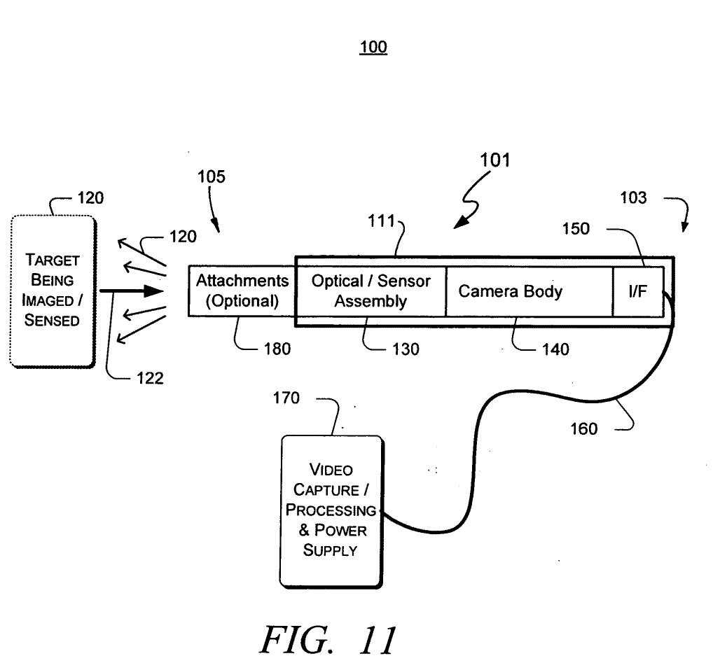

FIG. 11 is a block diagram illustrating a multisensory device imaging a target and interfacing with a video capture component;

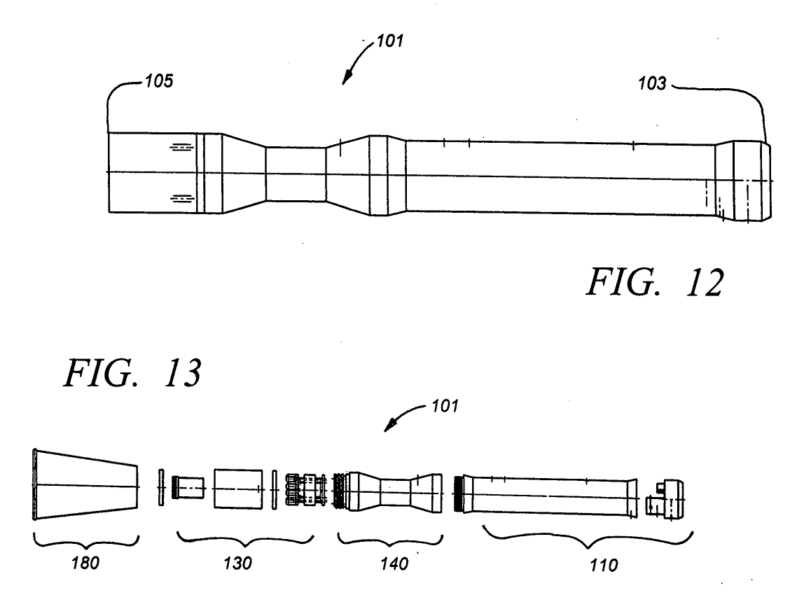

FIG. 12 is a side view illustrating a handheld video examination camera in accordance with one embodiment of the invention;

FIG. 13 is an exploded view further illustrating the handheld video examination camera of FIG. 12;

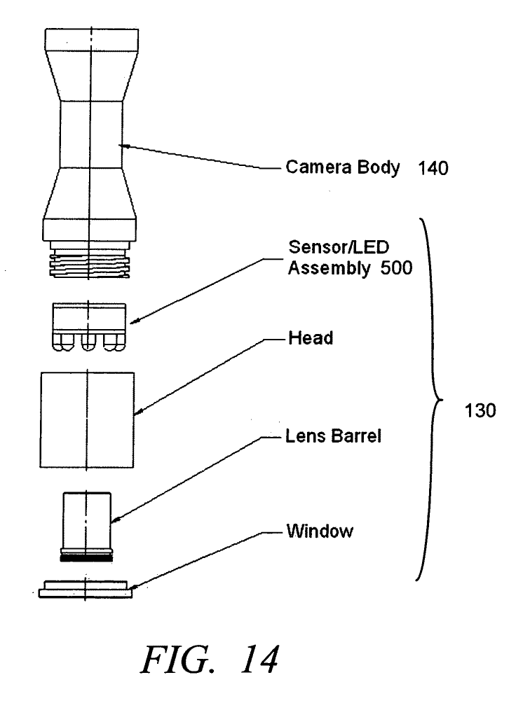

FIG. 14 is an exploded view further illustrating a portion of the camera of FIG. 12;

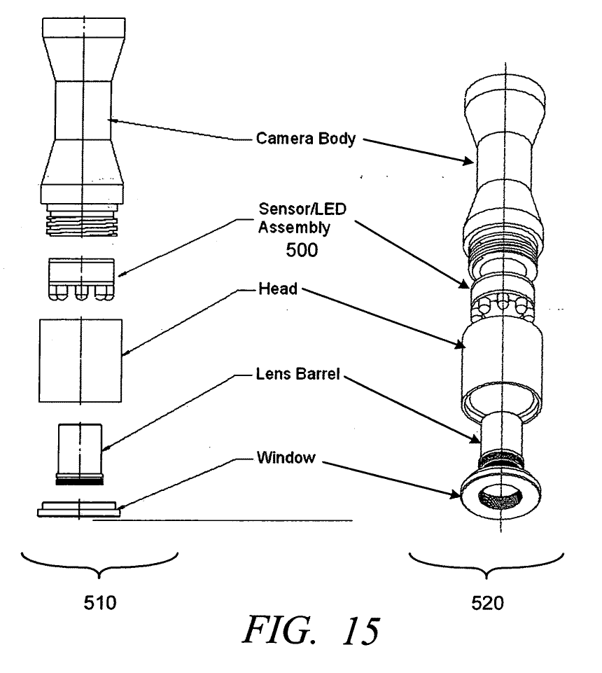

FIG. 15 further illustrates a portion of the handheld video examination camera of FIG. 12.

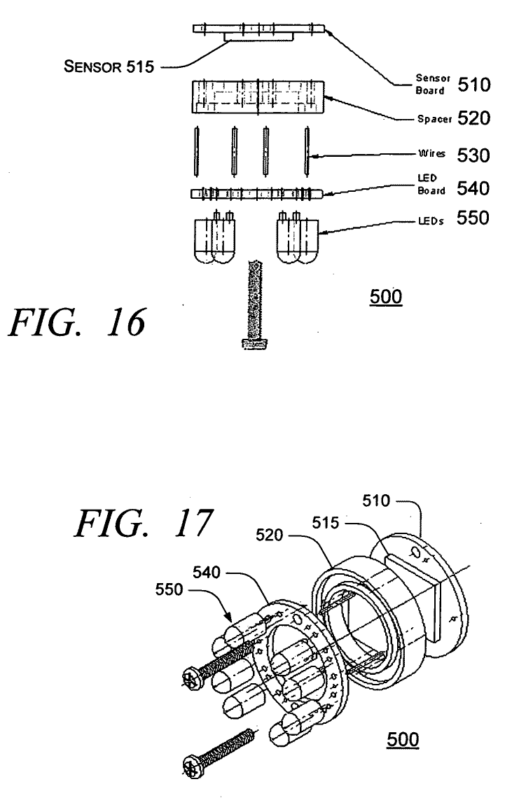

FIG. 16 is a side exploded view of a light-sensor construction in the camera of FIG. 13;

FIG. 17 is a perspective view further illustrating the light-sensor construction of FIG. 16;

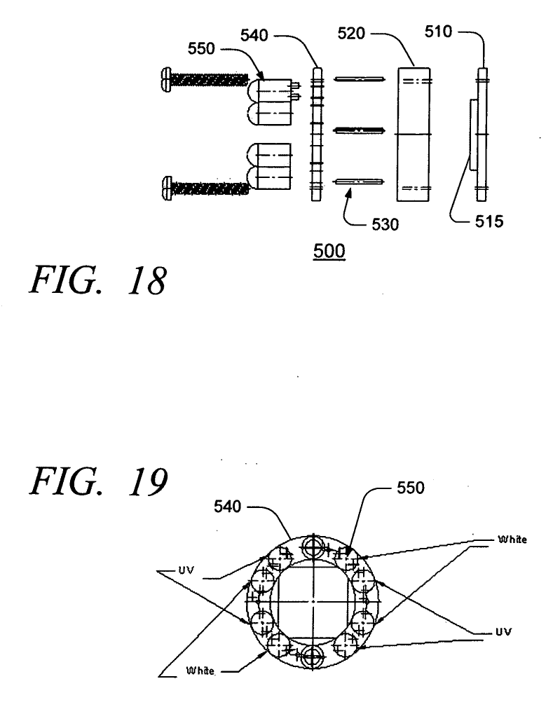

FIG. 18 is a side view further illustrating the light-sensor construction of FIG. 16;

FIG. 19 is a bottom view illustrating further illustrating the light assembly of FIG. 16;

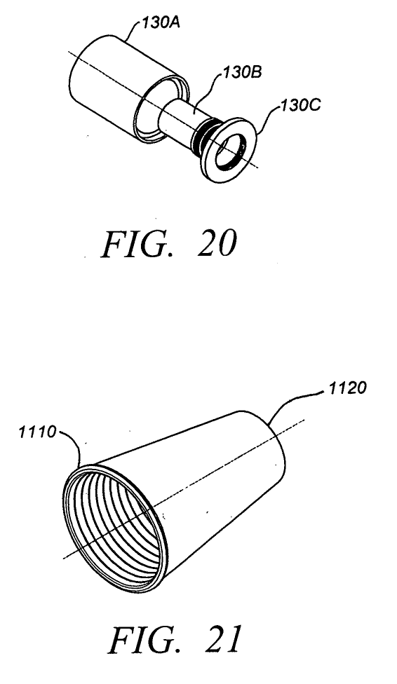

FIG. 20 is a side exploded view further illustrating the head of the camera of FIG. 16;

FIG. 21 is a side view illustrating an alternate embodiment of a hood that can be utilized with the camera of FIG. 13;

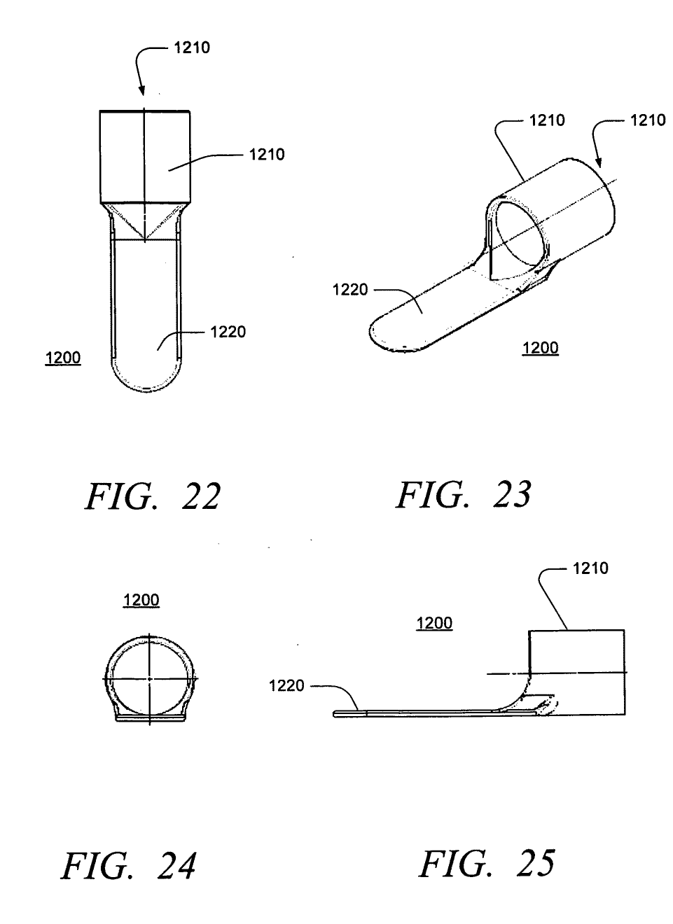

FIG. 22 is a side view illustrating a tongue depressor that can be utilized with the camera of FIG. 13;

FIG. 23 is a perspective view further illustrating the tongue depressor of FIG. 22;

FIG. 24 is a front view further illustrating the tongue depressor of FIG. 22;

FIG. 25 is a side view further illustrating the tongue depressor of FIG. 22;

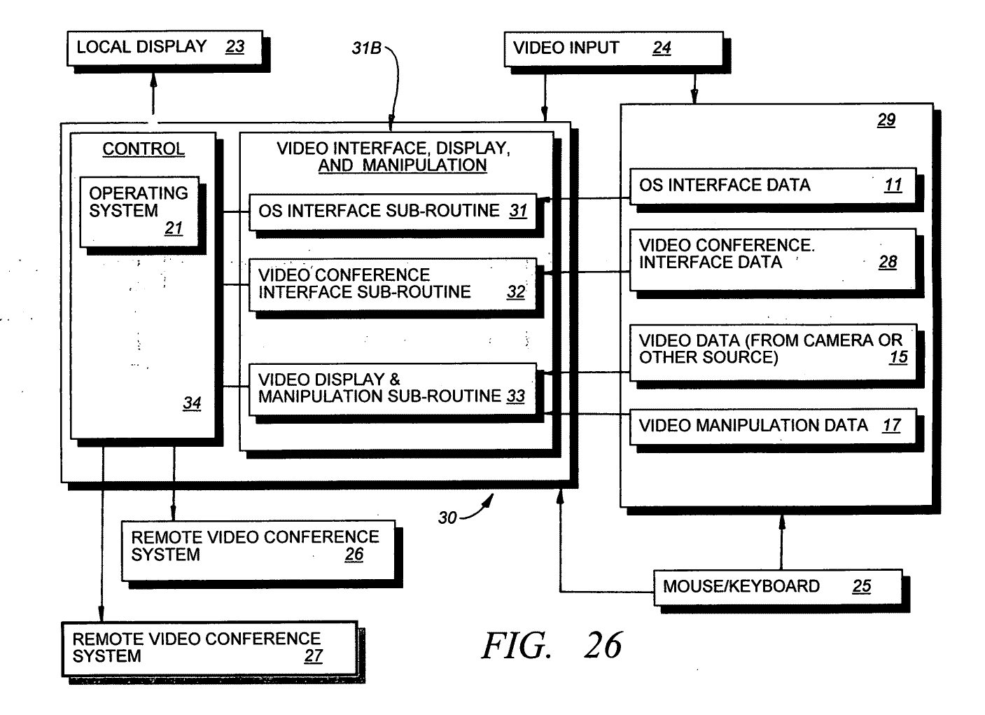

FIG. 26 is a block flow diagram illustrating an improved video conferencing system in accordance with one embodiment of the invention;

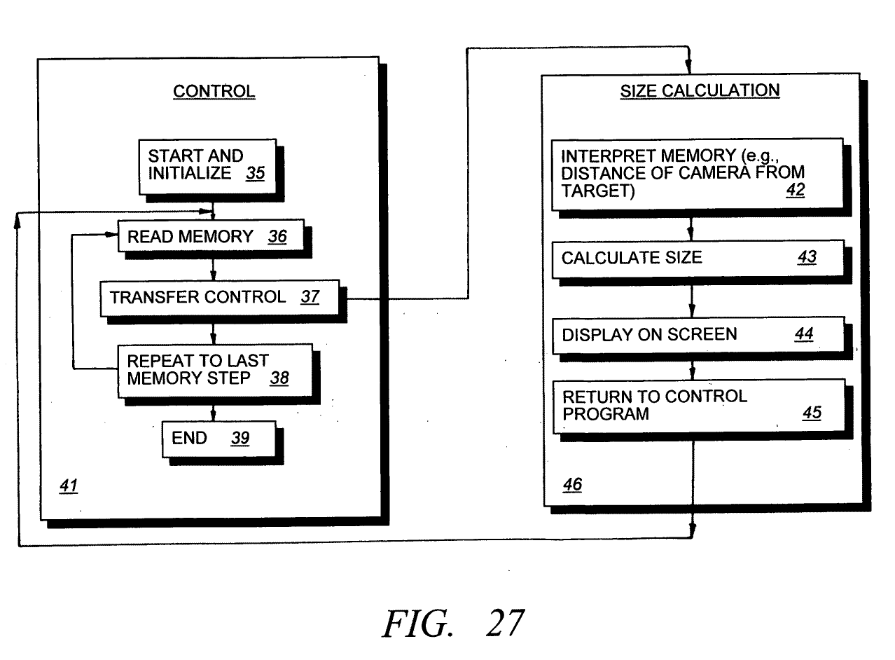

FIG. 27 is a block flow diagram which illustrates a typical program or logic function utilized in accordance with the embodiment of the invention in FIG. 26;

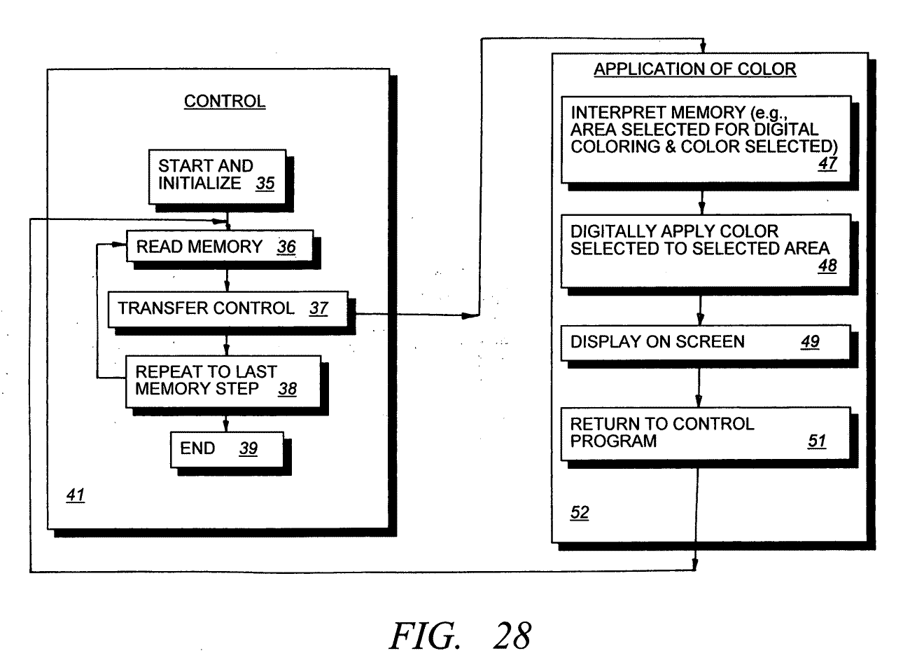

FIG. 28 is a block flow diagram which illustrates another typical program or logic function utilized in accordance with the embodiment of the invention in FIG. 26;

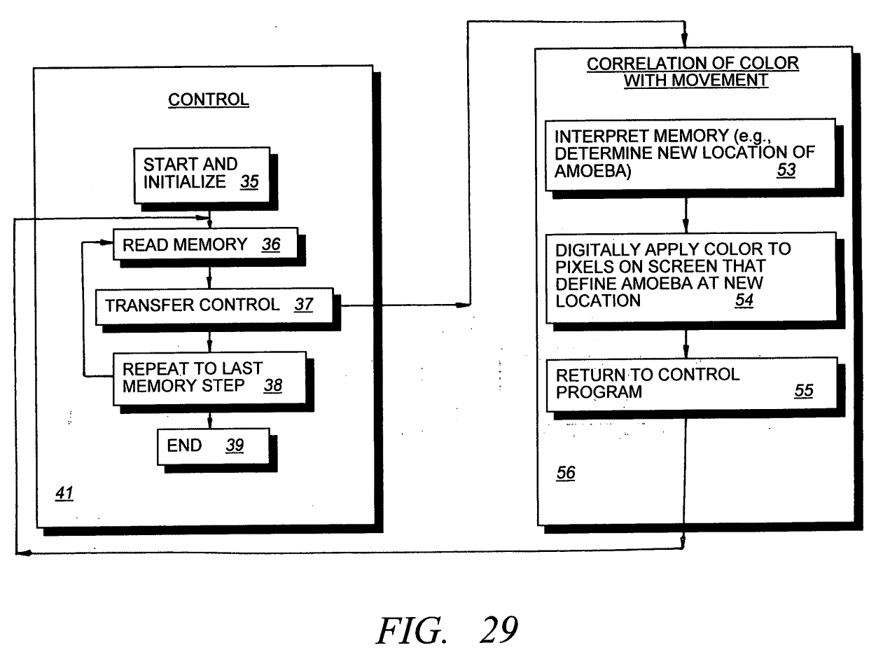

FIG. 29 is a block flow diagram which illustrates another typical program or logic function utilized in accordance with the embodiment of the invention in FIG. 26;

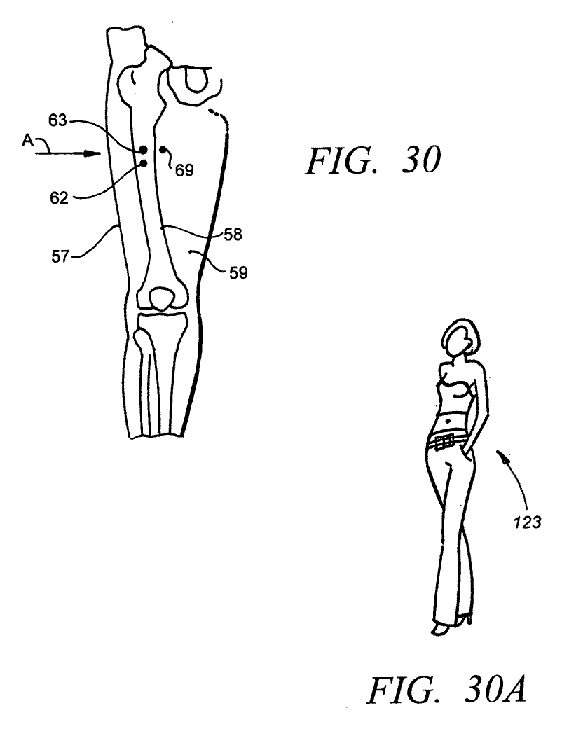

FIG. 30 is a front view illustrating the location of moles on the front of the thigh of an individual's right leg;

FIG. 30A is a front view illustrating the individual of FIG. 30;

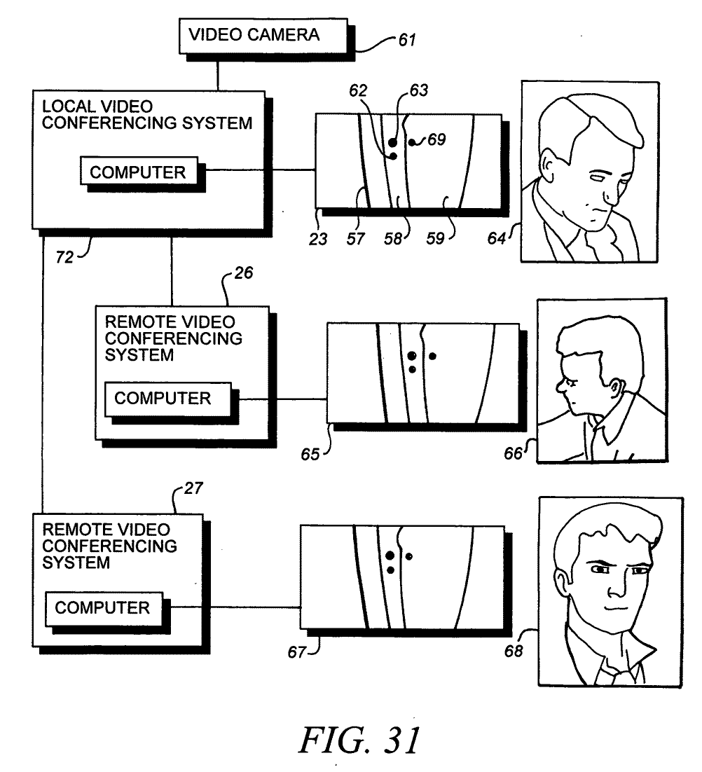

FIG. 31 is a block diagram illustrating the simultaneous real time viewing on displays operating at several different locations of an image of the leg of FIG. 30 that is produced by a video camera;

FIG. 32 is a block diagram further illustrating the simultaneous real time viewing on displays operating at several different locations of an image of the leg of FIG. 30 that is produced by a video camera;

FIG. 33 is a block diagram further illustrating the simultaneous real time viewing on displays operating at several different locations of an image of the leg of FIG. 30 that is produced by a video camera;

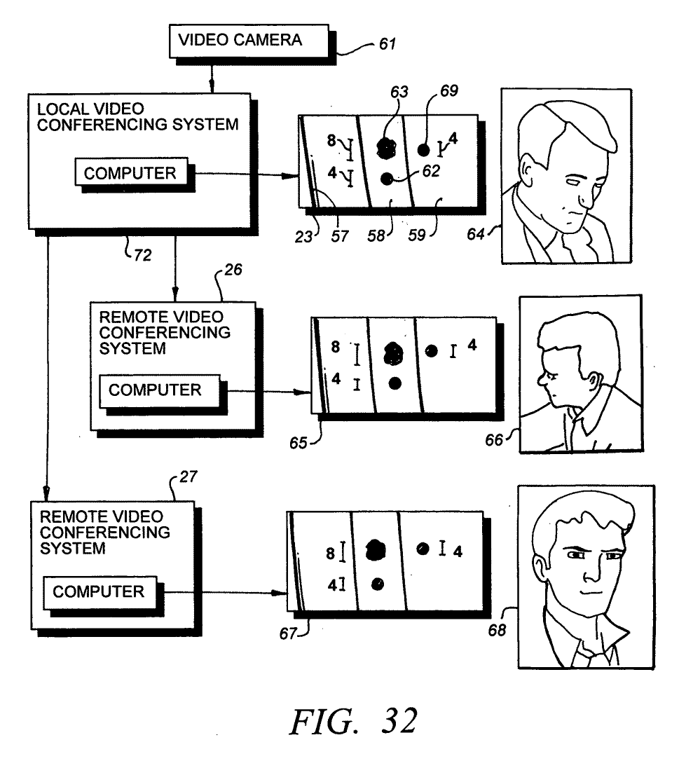

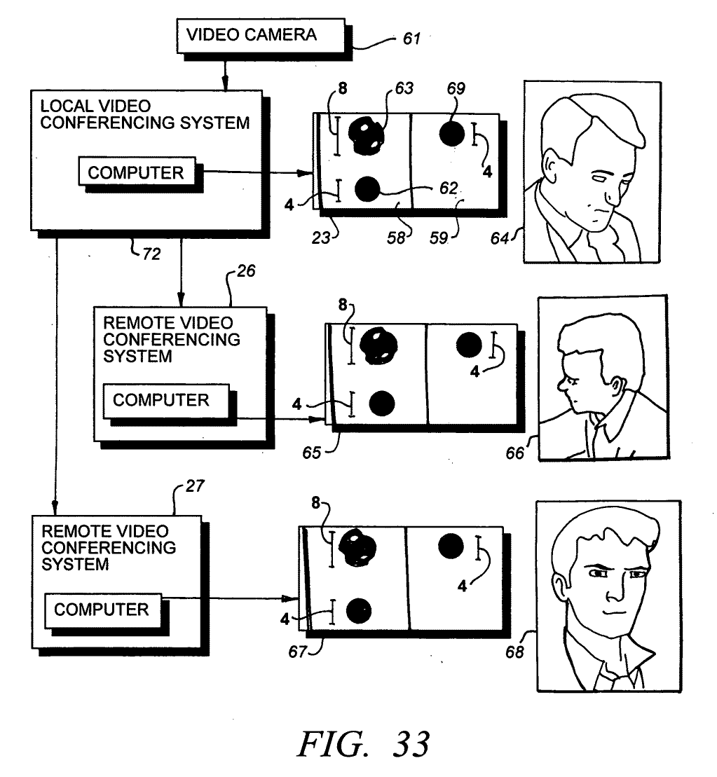

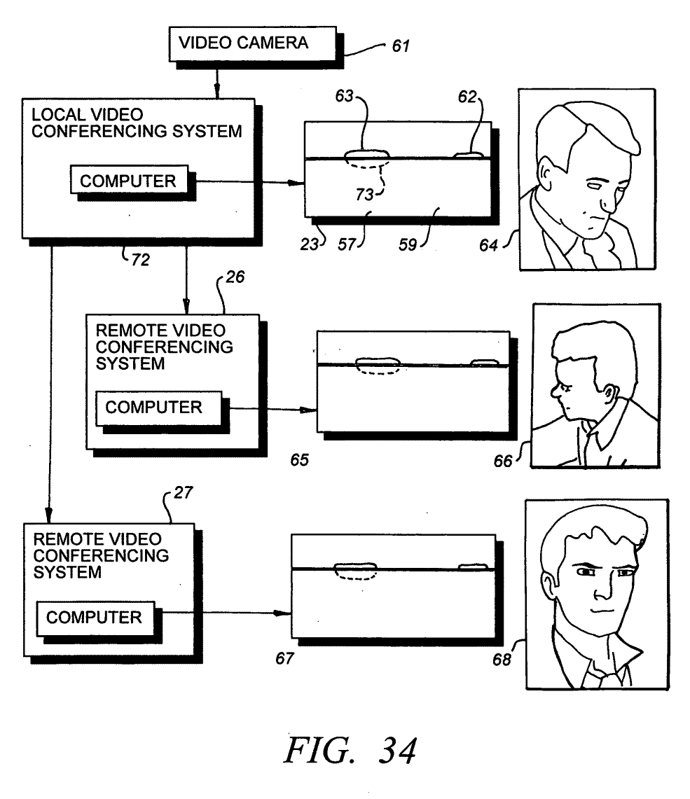

FIG. 34 is a block diagram further illustrating the simultaneous real time viewing on displays operating at several different locations of an image of the leg of FIG. 30 that is produced by a video camera;

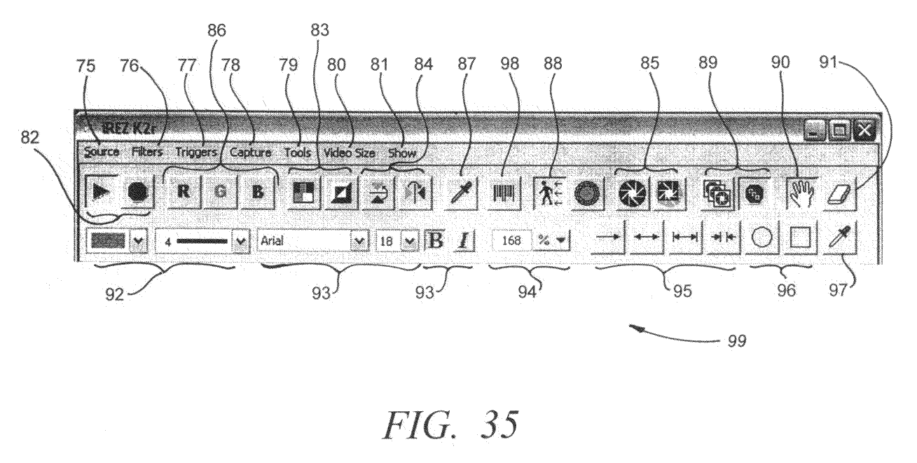

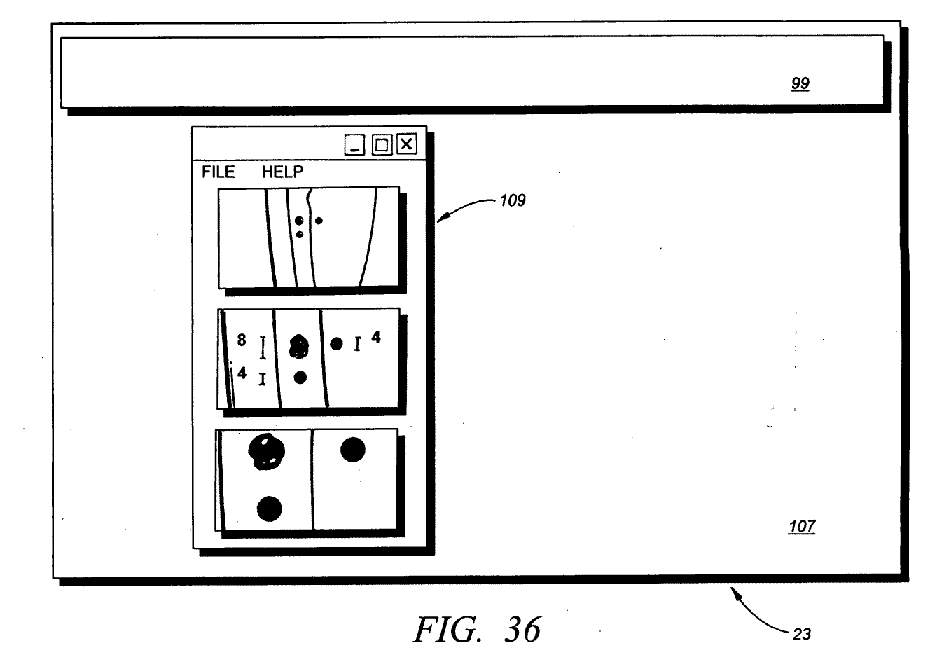

FIG. 35 is a diagram illustrating the control button menu utilized in the main monitoring window illustrating in FIG. 36;

FIG. 36 is a diagram illustrating the main monitoring window utilized in conjunction with the video conferencing system in accordance with one embodiment of the invention;

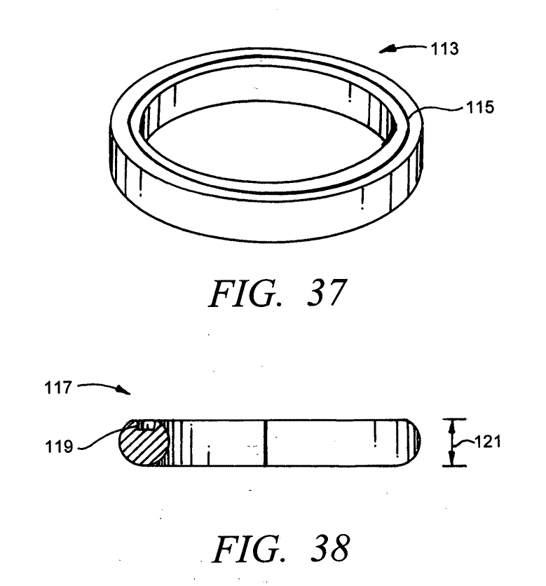

FIG. 37 is a perspective view illustrating a dermacollar constructed in accordance with the invention;

FIG. 38 is a perspective view illustrating another embodiment of a dermacollor constructed in accordance with the invention;

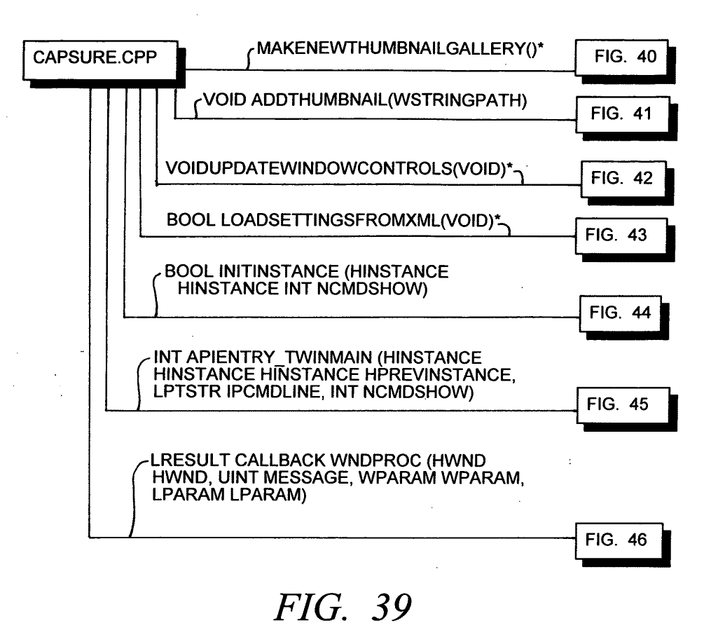

FIG. 39 is a block diagram illustrating an overview of a computer program 31B that can be utilized in accordance with the invention;

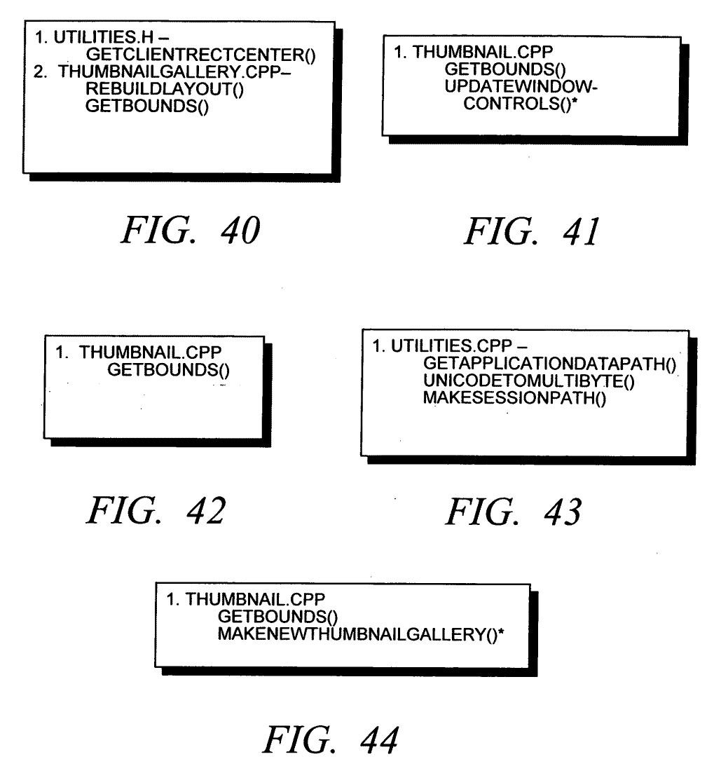

FIG. 40 is a block diagram illustrating a component of the computer program of FIG. 39;

FIG. 41 is a block diagram illustrating a component of the computer program of FIG. 39;

FIG. 42 is a block diagram illustrating a component of the computer program of FIG. 39;

FIG. 43 is a block diagram illustrating a component of the computer program of FIG. 39;

FIG. 44 is a block diagram illustrating a component of the computer program of FIG. 39;

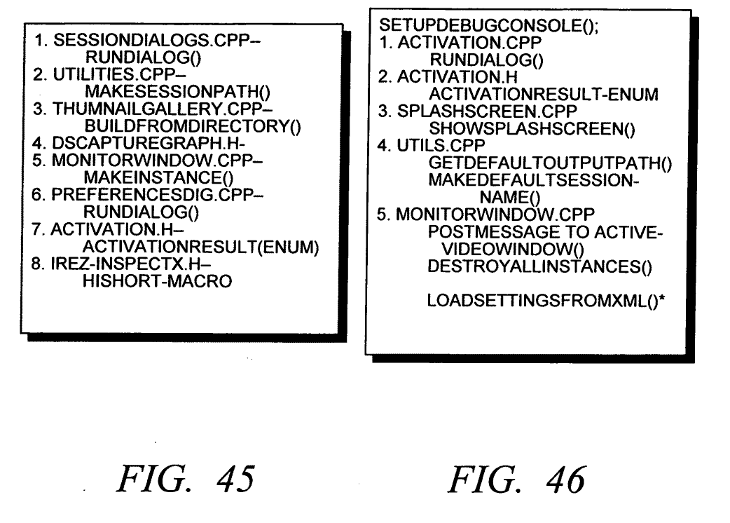

FIG. 45 is a block diagram illustrating a component of the computer program of FIG. 39; and,

FIG. 46 is a block diagram illustrating a component of the computer program of FIG. 39.

Briefly, in accordance with the invention, provided is a method of digitally staining an object comprising viewing a live digital image of an object, wherein the object includes a first element and a second element, and wherein the live digital image is comprised of a plurality of pixels and modifying the values of plurality of pixels in the image, wherein the values are selected from a group consisting of chrominance values and luminescence values, and wherein the modification results in a digitally stained image, wherein the first element is stained a first color and the second element is stained a second color. The chrominance values of the pixels can be modified using parametric controls, wherein the chrominance value of a first pixel that falls into a first calculated chrominance range is modified to reflect the mean of a first 9Bloc. The chrominance value of a second pixel that falls into a second calculated chrominance range can be modified to reflect the chrominance mean of a second 9Bloc. An edge between the first element and the second element can be determined by comparing the high and low chrominance values of the 16 pixels surrounding the 9Bloc relative to the mean of the 9Bloc, wherein when the chrominance mean of one of the surrounding pixels of the 9Bloc falls above or below a pre-calculated high or low threshold, an edge is demarcated. A microscopic slide can be stained and the image inversed digitally to simulate a dark-field environment. The pixels in the image can include pre-processed pixel information from an imaging sensor. The imaging sensor can be selected from a group consisting of a CCD imaging sensor, a CMOS imaging sensor, or any optical scanning array sensor. RGB values of the pixels can be transcoded to YUV values. The RGB values can be transcoded to YUV values using an algorithm including:

Y=0.257R+0.504G+0.098B+16

U=−0.148R−0.291G+0.439B+128

V=0.439R−0.368G−0.071B+128

The digital video image can be viewed in real-time. The real-time video pixel can be selected from a group consisting of either monochromatic and polychromatic pixels. High and low chrominance values can be selected based on a reference nine bloc pixel. The luminance values and chrominance values can be controlled, with the luminance values being controlled independently of the chrominance values.

The present invention also includes a chrominance enhancing method or technique, comprising digitally changing the chrominance and/or luminance value(s) of either pre- or post-processed individual pixel information of a CCD or CMOS imaging sensor through software and/or firmware digital filters. The method also includes real-time video that is either monochromatic or polychromatic. The present invention also includes a method of enhancing a live video image with respect to an image's individual R, G and B pixel values, thereby obtaining a modified outline of a subject displayed on a computer monitor.

In another embodiment of the invention, a computer-readable storage medium containing computer executable code for instructing a computer is provided to perform the steps of copying an image comprised of a first element and a second element, wherein the first element and second element are each comprised of a plurality of pixels and each pixel has an RGB value; transcoding the RGB values of the plurality of pixels into YUV values; and, modifying the YUV values of the plurality of pixels in the image, wherein the YUV values are selected from a group consisting of chrominance values and luminescence values, and wherein the modification results in a digitally stained image, wherein the first element is stained a first color and the second element is stained a second color. The digitally stained image can be displayed on a computer monitor. The RGB values can be transcoded to YUV values using an algorithm, wherein the algorithm includes

Y=0.257R+0.504G+0.098B+16;

U=−0.148R−0.291G+0.439B+128; and

V=0.439R−0.368G−0.071B+128.

The RGB value of a stain color can be alpha blended with the RGB of one of the plurality of pixels. The stain color and the pixel can be alpha blended using an algorithm, wherein the algorithm includes

If ((copy_pixel_Y<=Y_high) && (copy_pixel_Y>=Y_low) &&
(copy_pixel_U<=U_high) && (copy_pixel_U>=U_low) &&
(copy_pixel_V<=V_high) && (copy_pixel_V>=V_low))
{orig_pixel_R=alpha*stain_R+(1.0−alpha)*orig_pixel_R;
orig_pixel_G=alpha*stain_G+(1.0−alpha)*orig_pixel_G;
orig_pixel B=alpha*stain_B+(1.0−alpha)*orgpixelgB;}

In a further embodiment of the invention, a method of enhancing a live video image includes the steps of viewing a live digital image of an object, wherein the object includes a first element and a second element, and wherein the live digital image is comprised of a plurality of pixels; modifying the values of a plurality of pixels in the image, wherein the values are selected from a group consisting of chrominance values and luminescence values, and wherein the modification results in a digitally stained image, wherein the first element is stained a first color and the second element is stained a second color; and, allowing movement of the object, wherein the first element remains stained the first color and the second element remains stained the second color while the object is moving.

In still another embodiment of the invention, a method is provided to transcode RGB chroma values into YUV color space for the purpose of controlling the luminance and chrominance values independently by selecting the high and low chroma values based on a single selected nine bloc pixel. An image's YUV color space can be used in employing the luminance, chrominance and alpha information to increase or decrease their values to simulate a chemical stain while using parametric type controls.

In still a further embodiment, the present invention relates to digitally enhancing a live image of an object using the chrominance and/or luminance values which could be received from a CMOS- or CCD-based video camera; and more specifically to digitally enhancing live images viewed through any optical or scanning inspection device such as, but not limited to, microscopes (dark or bright field), macroscopes, PCB inspection and re-work stations, medical grossing stations, telescopes, electron scopes and Atomic Force (AFM) or Scanning Probe (SPM) Microscopes and the methods of staining or highlighting live video images for use in digital microscopy and spectroscopy.

Turning now to the drawings, which are provided by way of explanation and not by way of limitation of the invention, and in which like reference characters refer to corresponding elements throughout the several views, FIGS. 1 to 8 pertain to a chrominance or luminance enhancing method or technique comprised of digitally changing the chrominance and/or luminance values of either pre- or post-processed “live” individual pixel information of a CCD or CMOS imaging sensor through software or firmware. This can also be described as a method of enhancing a live video image with respect to the image's individual R, G, and B (Red, Green, Blue) pixel values, thereby obtaining a modified outline of the subject displayed on a computer monitor or other types of image viewing devices known in the art.

FIG. 1 illustrates one example of an apparatus suitable to carrying out the disclosed method. Digital Staining Device 10 includes microscope 12 and digital video camera 14. Camera 14 can be any type of CCD or CMOS imaging sensor known in the art. In FIG. 1, microscope 12 is a color CCD video-based microscope system that allows the user to view small objects on video monitor 16 through camera 14. Other suitable viewing systems can be used.

According to FIG. 1, light 18 is used to provide illumination for viewing the target object 20 on the video monitor 16. Light 18 can be natural light, artificial light, such as overhead room lights, or can be a light source particular to the staining apparatus, such an LED light, Raman fixed-focus laser or a standard halogen microscope light aperture. According to FIG. 1, video monitor 16 is a computer monitor connected to computer 22. Computer 22 runs the software or firmware that digitally changes the chrominance and/or luminance values of either pre- or post-processed individual pixel information received from camera 14.

Digital staining device 10 is capable of live, stained inspection methods in the applications of semiconductor, printed circuit boards, electronics, tab and wire bonding, hybrid circuit, metal works, quality control and textiles. Digital staining device 10 can also be any optical or scanning inspection device such as, but not limited to, microscopes (dark or bright field), macroscopes, printed circuit board inspection and re-work stations, medical grossing stations, telescopes, fiber optic splitting, Electron, Atomic Force (AFM) or Scanning Probe (SPM) Microscopes and the methods of staining or highlighting live video images for use in digital microscopy, histogroscopy and spectroscopy.

According to this invention, a chemical, florescent or other stain can be simulated when the YUV color space image uses the luminance, chrominance and alpha information to increase or decrease its values based on the pre-calculated parametric controls. This invention can further be used to digitally stain a microscope slide and then digitally inverse the image to highlight a region of interest or completely turn deselected pixels to black in order to simulate a dark-field environment. As shown in FIG. 6, this invention is also particularly useful in enhancing traces of a Ball Grid Array (BGA) component on a printed circuit board during visual inspection for real-time spectroscopy and quality control.

Digital staining device 10 is also capable of producing “live” or real-time staining of moving objects such as small organisms, single-celled organisms, cell tissue and other biological specimens. Specifically, the present invention discloses a method of digitally staining an object comprising: viewing a live digital image of an object, wherein the object includes a first element and a second element or more, and wherein the live digital image is comprised of a plurality of pixels; and modifying the values of a plurality of pixels in the image, wherein the values are selected from a group consisting of chrominance values and luminance values, and wherein the modification results in a digitally stained image, wherein the first element is stained a first color and the second element is stained a second color, and the third element is stained a third color and so on.

The present invention is also useful in detecting embedded digital signatures within a photograph, in enhancing a fingerprint in a forensics laboratory, or in highlighting a particular person or figure during security monitoring. According to the present invention, the method described above will hereinafter be referred to as Chroma-Photon Staining or CPS. It should be noted that the following explanation uses 8-bit values for the RGB and YUV color components, by way of example only. However, the CPS technique is not limited to 8-bit values.

The imaging sensors, such as camera 14, are usually arranged in Red, Green, Blue (RGB) format, and therefore data is obtained from these video sensors in RGB format. However, RGB format alone is inadequate for carrying out the method according to the present disclosure, in that RGB format does not permit separating the chrominance and luminance values. Therefore, the present invention ultimately utilizes the YUV color space format. YUV color space allows for separating the chrominance and luminance properties of RGB format. Thus, according to the invention, the RGB values are trans-coded into YUV color space using an algorithm for the purpose of controlling the chrominance and luminance values independently. This is accomplished by selecting the high and low chroma values based on a 9Bloc (defined below) of a single selected pixel. FIG. 2A illustrates an RGB Bayer Pattern, while FIG. 2B illustrates the chroma filter by way of a Bayer Pattern example.

As shown in FIG. 2B, the chrominance values of the pixels are modified using real-time parametric controls, wherein the chrominance value of a first pixel that falls into a first calculated chrominance range is modified to reflect the mean of a 9Bloc of pixels. According to this invention a 9Bloc is a union of nine pixels, three high and three wide. The center pixel is the reference (or defining) pixel and the surrounding dihedral group of the neighboring 8 pixels completes the 9Bloc. As shown in FIG. 2B, and by way of example only, R is the center pixel and the reference pixel. In FIGS. 2A and 2B, the reference character R indicates a red pixel, the reference character B indicates a blue pixel, and the reference character G indicates a green pixel.

In one embodiment, the method further demarcates an edge between the first element and the second element by comparing the high and low chrominance values of the 16 pixels surrounding the 9Bloc—in other words, the outer edge of a pixel block that is 25 pixels (five high and five wide), hereinafter denoted as a 25Bloc, with the mean of the 9Bloc (or the new value of the reference pixel). When the chrominance mean of one of the surrounding pixels rises above or falls below a pre-calculated high or low threshold relative to the mean of the 9Bloc, an edge is demarcated. FIG. 3 illustrates one example of the edge filter.

As shown in FIG. 3, the CPS edge filter looks for edges by comparing the high and the low chrominance values of the adjacent three pixels, the adjacent two pixels and the adjacent one pixel of the selected reference pixel (9Bloc). This is very different from the Canny and Di Zenzo algorithms as they compute the magnitude and direction of the gradient (strength and orientation for the compass operator) followed by non-maximal suppression to extract the edges. The CPS technique uses levels or magnitudes of color relative to the mean of the selected 9Bloc chosen to stain. The CPS filter simply looks beyond the 9Bloc in each direction. First one pixel out, then two, and then three in each direction, calculating the mean each time. This feature can be turned off or on within the filter. This technique can keep the stain concentrated to selected areas of the object and instead of the entire viewing scene. The example in FIG. 3 is demonstrative of this feature of the invention.

FIG. 4 illustrates the parametric staining point, stain intensity and stain chroma range according to the present disclosure. The stain point is the 9Bloc selected by the user for staining, the stain intensity is the luminance value above the selected 9Bloc and the stain chroma range is bandwidth of the chrominance value relative to the 9Bloc selected. CPS allows the spectroscopic stain maker to work in real-time with the live image which may or may not be chemically stained. Controlling the lighting environment is important for the CPS technique to have favorable results. Keeping a consistent “flood” of light and light temperature assists in obtaining consistent staining.

To better control the color conversion of the data from a camera sensor, the present process converts or “transcodes” the Red, Green and Blue (RGB) data into YUV 4:4:4 color space. As shown in FIG. 4, Blue also can be expressed as Cb-Y; Green as Cg-Y; and Red as Cr-Y.

Instead of each pixel having three color values, RGB, the color information is transcoded to CbCr color which is the U and V values. According to the present disclosure:

U=Cblue [1]

V=Cred [2]

The YUV conversion is accomplished according to the following equations:

Y=0.257R+0.504G+0.098B+16 [3]

U=−0.148R−0.291G+0.439B+128 [4]

V=0.439R−0.368G−0.071B+128 [5]

According to the present disclosure, the Y is the luma value. In one embodiment of the present disclosure, the user controls this feature independently from the color values, so the entire equation is:

Y=CbCr [6]

Green color is calculated by subtracting Cr from Cb, and the equation is:

Cg=Cb−Cr [7]

All notations are in hex values of FF(h) or less for 8 bit camera sensors and 400(h) for 10 bit camera sensor. The CPS technique does not involve any sub-sampling, thus, there is no color loss during the transcoding. Further, there is no compression.

Another issue with camera sensors and the CPS technique is that its accuracy is subject to the data received. High-grade CCDs have much higher dynamic range and signal to noise ratio (SNR) than that of consumer grade CCDs or CMOS sensors. Sensors with 8 bit outputs will have far less contrast and DR than that of a 10 or 12 bit sensor. Other sensor issues such as temporal noise, fixed pattern noise, dark current and low pass filtering also come into play with the pre-processed sensor data. Dynamic Range (DR) quantifies the ability of a sensor to adequately image both highlights and dark shadows in a scene. It is defined as the ratio of the largest non-saturating input signal to the smallest detectable input signal. DR is a major factor of contrast and depth of field.

With this in mind, when the CPS technique is carried out, a high-grade camera is preferred over a low-grade camera. However, the present disclosure envisions taking the particular conditions of the camera into consideration when using the CPS method. Still, the implementation of the present disclosure envisions using a high-grade CCD and a 10 or 12 bit sensor for optimal results.

Referring back to FIG. 2B, when the user clicks the mouse in the video frame or otherwise designates a reference pixel, the RGB values of the pixel under the pointer and of the eight adjacent pixels around the point are averaged to produce a single RGB sample pixel. In FIG. 2B, and by way of example only, R is the reference pixel and would be the pixel chosen by the pointer. Thus, in FIG. 2B, the reference pixel is the center pixel in the 9BLOC.

Modification or filtering of the 9Bloc pixels is accomplished by averaging the four Green and four Blue pixel values with the one R value and arriving at certain averaged value, here equal to a value “A.” Therefore, with respect to FIG. 2B:

A=mean9Bloc=mean(4G plus 4B plus 1 R) [8]

Thus, A is also the new value of the reference pixel. In FIG. 2B, the 25 block of pixels is then modified by first averaging the outside sixteen pixels. This is accomplished by averaging the eight Green and eight Red values to arrive at a certain average value, here equal to a value “B.” Thus, with respect to FIG. 2B:

B=mean of the outside 16 pixels of the 25Bloc=mean(8G and 8R) [9]

The modification of the 25Bloc is then accomplished by the following equation:

C=mean(A and B) [10]

The reference pixel contains three, 8-bit values, ranged 0 to 255 for each red, green and blue component. These RGB values are then transformed into YUV color space using the equations:

Y=0.257R+0.504G+0.098B+16 [11]

U=−0.148R−0.291G+0.439B+128 [12]

V=0.439R−0.368G−0.071B+128 [13]

The final 8-bit YUV component values represent the key pixel that is then used as the mean for the current bandwidth ranges. The bandwidth is an 8-bit value that represents the deviation above and below a component key pixel value that determines the bandwidth range for a color component. There are two bandwidth values used by the CPS technique: the first is applied to the luminance component (Y) of the key pixel while the second is applied to both chrominance components (U and V) of the key pixel. These values are saturated to the 0 and 255 levels to avoid overflow and underflow wrap-around problems. Thus:
Y_high=Y_key+luma_bandwidth;
   If (Y_high>255)
   Y_high=255;
   Y_low=Y_key−luma_bandwidth;
   If (Y_low<0)
   Y_low=0;
   U_high=U_key+chroma_bandwidth;
   If (U_high>255)
   U_high=255;
   U_low=U_key−chroma_bandwidth;
   If (U_low<0)
   U_low=0;
   V_high=V_key+chroma_bandwidth;
   If (V_high>255)
   V_high=255;
   V_low=V_key−chroma_bandwidth;
   If (V_low<0)
   V_low=0;
      Referring now to FIG. 5, RGB enters the RGB frame buffer 40 in step 102. The RGB Frame Buffer is a very large area of memory within the host computer that is used to hold the frame for display. A copy is then made of an incoming RGB video frame in step 104. This copy is then transformed into a YUV 4:4:4 color space format using equations [11], [12] and [13] in step 106, and is stored in the YUV frame buffer 50 in step 108. The video frame is stored in the YUV Frame buffer long enough to hand off to a CPS filter 60 in step 110 and blended with a staining color 70 of the user's choice, in step 112.

Next, the CPS technique is applied in step 114. In step 114, each YUV component of each pixel in the copied video frame is checked against the high and low bandwidth ranges calculated above. In step 114, if all YUV components of a pixel fall within the bandwidth ranges, then the corresponding pixel in the original RGB frame is stained. The stain color is an RGB value that is alpha blended with the RGB value of the pixel being stained.

The alpha blend value ranges from 0.0 to 1.0. The alpha blending formula is the standard used by most production switchers or video mixers known in the art. Thus, alpha blending is accomplished according to the following:
If ((copy_pixel_Y<=Y_high) && (copy_pixel_Y>=Y_low) && (copy_pixel_U<=U_high) && (copy_pixel_U>=U_low) && (copy_pixel V<=V_high) && (copy_pixel_V>=V_low)) {orig_pixel_R=alpha*stain_R+(1.0−alpha)*orig_pixel_R;
orig_pixel_G=alpha*stain_G+(1.0−alpha)*orig_pixel_G;
orig_pixel B=alpha*stain_B+(1.0−alpha)*orig_pixel_B;}

In step 116, the stained RGB pixels enter the RGB frame buffer, and in step 118, the stained RGB image is produced.

Finally, multiple stains, each with their own key pixels, bandwidths and stain colors, may be applied to the same video frame in order to demarcate elements of the target object. FIG. 6 illustrates one application of the chroma-photon staining method. FIG. 6 is an illustration of a tri-stain using the CPS technique in RGB color space of a Printed Circuit Board. In FIG. 6, the reference character R indicates areas stained red, the reference character B indicates areas stained blue, and the reference character Y indicates areas stained yellow.

FIG. 7 shows a second application of the chroma-photon staining method.

FIG. 7 is an illustration of a live sample stained using the CPS technique in RGB color space. The live sample comprises a liver cell at a microscopic power of 100× magnification. In FIG. 7 the reference character P indicates areas stained purple, and the reference character G/B indicates areas of the cell stained green or blue.

FIG. 8 is a regional stain isolating out a region-of-interest within a pre-H/E (Hematoxylin & Eosin or H&E) stained tissue sample magnified at 250×. In FIG. 8, the reference character Y indicates areas stained yellow, the reference character R indicates areas stained red, and the reference character P/B indicates areas stained purple or blue.

FIG. 9 is a block diagram illustrating a video conferencing system in accordance with one embodiment of the invention. A camera, preferably a digital camera, or other video source 101 is mounted on a microscope or other optical instrument and produces a video image that is received by the video capture and processing module 120. Module 120 digitally processes the video image and can, if desired, allow or enable modification or recompositing 130 of the video image via real-time markup or other processing techniques. Real-time markup can be accomplished by using a data entry device like a touch screen and stylus, mouse and monitor, keyboard, or other data entry device. One processing technique that can be used to modify a video image is the Chroma Photon Staining (CPS) technique described above. After a video image is modified by real-time markup, CPS, etc., the digital image is return to module 120 or is stored. Modules 120 can be utilized as stand-alone previewing monitors, to browse and manage images, to create image libraries or albums, to save or export raw-video images into usable data, to set up time exposures and lapse-time capturing, to place measurements and labels in video, or to catalog the history of a session and digitally “stain” the video via the CPS method.

One embodiment of the invention involves a technique referred to as “sessioning”. Sessioning allow storage of information from a video stream while the stream is processed in real-time. By way of example, consider a case in which a real-time video collaboration system is installed to allow a surgeon to broadcast annotated video showing a surgical procedure. The video is broadcast to a pathologist and other consulting health care providers. The surgeon provides real-time markups in the video showing a proposed incision line to excise a suspected tumor. The pathologist, who is at a location separate from that of the surgeon, views the video and either confirms the proposed incision line or suggests that the incision line be altered by moving the line, altering the length of the incision line, or altering the curvature, if any, of the incision line. While the surgeon subsequently makes the incision and continues to perform the surgery, the video, or portions thereof, are saved to computer memory for later recall. One way in which portions of the video can be saved is for the surgeon, or one of the surgeon's assistants, to manually intermittently command the system to save a still picture of what the video stream is displaying at a particular instant in time. Another similar procedure comprises entering commands into the system which cause the system to store still picture images at pre-set periodic intervals. A further procedure comprises commanding the system to “take” and store a still picture of what the camera is viewing at the instant the system detects movement of or in the area or object viewed by the camera. Another procedure comprises commanding the system to store a still picture of what the camera is viewing at the instant there is a detected color change in the image viewed by the camera. Still a further procedure comprises commanding the system to store a still picture of what the camera is viewing if there is a change in contrast in the image viewed by the camera. Other procedures, without limitation, can command the system to store a still picture of whatever the camera is viewing if there is a markup of the video image being entered, if an audio keyword or command is recognized by the system, or if there is a change on the power status of an electronic device monitored by the system. In addition to still pictures, the system can store, for later forwarding or review, longer segments of the video produced by the camera.

CPS can, by way of example and not limitation, be utilized to embed a digital signature in a photograph, to produce a biopsy stain for a slide viewed by a microscope, to enhance a fingerprint in a forensics laboratory, to highlight a person or object viewed by a security monitoring system, and to enhance traces on a printed circuit board in real time during visual inspection of the circuit board.

In one embodiment of the video system of the invention, a computer program for digitally processing a video produced by a camera can identify and store the name given an image (in a still picture taken from the video), the type of image (for example, jpg, bmp, tif, png, et.), image memory size in kilobytes, image shape and size (e.g. “x” by “y” pixels), bytes deep per pixel, contrast level, gamma level, color level, hue level, brightness level, whether auto exposure was on, date on which the picture or video taken, name of the user who saved an image, color weight spectrum percentage by R, G, B, number of CPS layers, CPS weight by percentage over non-CPS pixels, scale reference (e.g., “x” pixels=“x” inches), whether a bar code is present and what kind (e.g., code 39, code 128, etc.), and, a notes field.

The output produced by module 120 of a video system of the invention can be in any desired format and can, for example, appear to software in another video conferencing system to be derived from other cameras 140. In this way, a digital DVI output can be provided to another computer's video input for further processing or display.

An alternate embodiment of the video conferencing system of the invention is illustrated in FIG. 10, and includes display 57, content display 58, main display 59, video display driver 17, HDX9000 62, high definition camera 61, POLYCOM CMA™ 69 (previously called VIAVIDEO LIVE)™), POLYCOM PVX™ 71, IREZ VIDEO CLIENT™ 74, CAPTURE™ 63, high definition camera 72, high definition camera 73, WDM (Windows Driver Model) 75, RGM to YUV 64, apply YUV filter 68, compositor 67, overlay 66, and YUV to RGB 65.

In one preferred embodiment of the invention, a video computer program 31A (FIG. 26) is provided that interfaces with the WINDOWS XP operating system (or other desired OS), functions as an extension of and interfaces with an iREZ camera, and interfaces with other video conferencing systems. The video computer program 31A has external dependencies (libraries) comprising a collection of subroutines or classes) including Axtel1.0, Microsoft Platform SDK9.0C, DXSDK1.0 and WINDDK1.0. The video computer program has internal dependencies including AxtelSDK, BaseClasses, IREZlicense, IREZvideo, SkeletonKey, and Xerces. Microsoft Platform SDK is a software development kit from Microsoft that contains header files, libraries, samples, document and tools utilizing the APIs required to develop applications for Microsoft Windows. AxtelSDK comprises software used for implementing bar codes. BaseClasses comprise standard Microsoft class and dynamic libraries. IREZlicense comprises software utilized to require a individual to obtain a license on-line after a selected period of time of “free” use has expired. IREZvideo comprises the interface between DirectX and the WINDOWS operating system (OS). DirectX is a set of development tools and is an interface for graphics and video for the WINDOWS operating system. SkeletonKey is software that checks and confirms a user ID number when a user contacts the manufacturer or distributor of the video computer program. Xerces is freeware that counts coded lines. Program 31A generates an interface comprising an output that look like a video driver such that other video conferencing computer programs and other programs will open and look at the output.

FIG. 36 illustrates the main monitoring window 107 that appears on a computer flat screen display or other display 23. Window 107 includes control button menu 99 and, typically, session window 109. Window 107 typically includes the image that is being viewed by a video camera. If desired, menu 99 and session window 109 can be “clicked off” or minimized to leave only the image produced by the video camera to fill, or substantially fill, window 107. Session window 109 depicts images saved from the current or earlier sessions. In FIG. 36, window 109 includes images shown in FIGS. 31 to 33 with respect to a session described in an EXAMPLE that is later set forth below.

FIG. 35 illustrates the control button menu 99 in more detail. The features provided in menu 99 can be varied as desired, and more, or fewer, “buttons” or features can be included in menu 99.

When a mouse is used to click on “Source” 75 at the top left corner of menu 99, a drop down menu appears in display window 107. The menu includes, at a minimum, the line items:
Run Video Source
Stop Video Source
Format Controls
Video Controls
   These can be “clicked” as desired to cause their associated menus to appear on the display screen.

When a mouse is used to click on “Filters” 76 in the top left corner of menu 99, a drop down menu appears in window 107. The menu includes the line items:
Red
Green
Blue
Chroma Stain
Greyscale
Negative
Flip Vertical
Flip Horizontal
   Each of these controls can be clicked as desired.

When a mouse is used to click on “Triggers” 77, a drop down menu appears which includes the line items:
Run Motion Detection
Stop Motion Detection
Reset Motion Detection
Motion Detection Properties . . .
   Each of these controls can be clicked as desired.

When a mouse is used to click on “Capture” 78, a drop down menu appears which includes the line items:
Capture Entire Still Frame
Capture Cropped Still Frame
Run Time Lapse Capture
Stop Time Lapse Capture
   Each of these controls can be clicked (e.g., clicked on using a mouse) as desired.

When a mouse is used to click on “Tools” 79, a drop down menu appears which includes the line items:
Grabber Hand
Pointer
Arrow Measurement
Extension Measurement
Gap Measurement
Ellipse
Rectangle
Chroma Staining Selector
Erase Last Object
Erase All Objects
Drawing Tool Properties
   Each of these controls can be clicked as desired.

When “Video Size” 80 is clicked, a drop down menu appears which includes the line items:
25%
50%
75%
100%
200%
300%
400%
500%
600%
Fit to Window
Reset
   Each of these controls can be clicked as desired.

When “Show” 81 is clicked, a drop down menu appears which includes the line items:
Name Frame Label
Data and Time Frame Label
Label Properties . . .
Motion Detection Region
Cursor Guides
Control Panel
Chroma Stain Controls
Calibration Definitions
   Each of these controls can be clicked as desired.

The Start/Stop buttons 82. The Start (preview) and Stop live video buttons work opposite each other in that they either freeze the video in the preview monitor window or start it.

The Chroma/Grey buttons 83. Clicking the first button will display either a 10 bit gray-scale or 8 bit color preview in real-time. Clicking the inversion button (2^{nd} button) will build a color or gray-scale negative for the live preview image. This feature is very handy when looking for small defects or details of a subject. The feature produces a “true” negative of the picture.

The Flip/Mirror buttons 84. This feature will either flip the video preview up side down or build a mirror image on the screen.

The Picture/Snap buttons 85. The Picture button takes a snapshot from the entire sensor and not just what is in the preview monitor window. To change this setting, choose the Source Menu, the Format Controls (not shown), and adjust the “Output” size. This determines the size of the image capture. Note that if you have panned to a corner of the image and select this button, you will get the entire image. The Snap button will capture a picture of what you see in the preview monitor window. If you are zoomed in and panned anywhere within the image, this feature grabs the image the way you want it. The quality of the image saved is determined by how you have set up the preferences menu (not shown). The default is set to the BMP format, which provides the best quality. Each image taken using the Picture button or the Snap button will auto save to the open session.

The Color Filter buttons 86. These three buttons are used to filter out Red, Green, or Blue or a combination of any three light waves. This feature is very useful when using different light sources and there is a need to isolate specific interest regions of color.

The Chroma Stain Filter button 87. This button turns on or off Chroma Staining.

The Motion Detection button 88. This button turns on or off motion detection. Program 31B detects motion by detecting a change in the color of a pixel. The change in the color of a pixel can be determined by monitoring changes in chrominance or luminescence, or both. Further, the program 31B permits the color sensitivity can be set to determine how much of a change in chrominance (and/or luminance) is required before program 31B will detect that an object, for example an amoeba, has moved. For example, if the sensitivity is set at 5%, then a 5% change in chrominance (and/or luminance) is required before the program 31B will determine that motion has occurred. Program 31B also permits a limited area on a display screen to be monitored. If a digital video camera is, via a microscope, viewing a fixed slide and an ameoba that is located on the slide and that appears in the lower left corner of the display screen, then the lower left corner of the display screen can be selected such that program 31B monitors only pixels in that area for motion.

In a related manner, program 31B permits an amoeba or other object being viewed with a digital video camera to be highlighted on a display screen 23 by selecting a particular color. If the amoeba has a peripheral wall that appears dark green, a user can position a cursor on the peripheral wall, click to identify the wall and the color of pixels that define the wall, and turn off other colors so that only dark green colors appear on the display. The remaining areas of the display are black or some other selected background color and the green walls of the amoeba likely will clearly stand out and be identifiable because most other areas being viewed by the digital video camera do not have the same color as the peripheral wall of the amoeba.

The Time Lapse buttons 89. These two buttons start and stop the time-lapse feature. The buttons will open another dialog box asking you how often you want the capture to take place, e.g., will ask you to set the capture rate. Anything more than one frame every 250 milliseconds will slow-down your system because of the immense processing power required.

The Hand button 90. This button allows you to “pan” within the preview monitor window. Simply place the hand over any area of the image, left-click. The hand will change into a grabbing hand and you will be able to drag the image in real-time.

The Erase button 91. The Erase button has two functions: Erase Last and Erase All. Click once on the Erase button and everything drawn will be erased. Hold down the Ctrl key and click on the Erase button and the last drawing or measurement recorded will be erased. The Erase button can be clicked to erase without deslecting any other options.

The Lines buttons 92. These buttons produce pull-down menus for specifying the color and width of lines.

The Font Control buttons 93. These buttons are used in conventional fashion to control font properties.

The Zoom button 94. Clicking on the percent arrow produces a pull-down menu that allows selection of a zoom level in the range of 20% to 600%. Zooming can also be done with the mouse wheel by holding the curser over the monitor window 107 and zooming in and out using the mouse's scroll wheel.

The Arrow Option buttons 95. These buttons let you choose a different measurement arrow(s) to appear in window 107 while measuring. The measuring tool has two functions: placing a measurement in the image and calibrating the measurement tool. To calibrate the tool, focus the camera clearly on a ruler or other measurement scale. Using the arrow button selected, select a distance on the measurement scale defined by a pair of ruled marks—say one millimeter—and click and hold the right mouse button down while dragging between two points (i.e., from one side to the other of the selected distance). Preferably, zoom in on the ruler to 120% and carefully position the mouse cross-hairs on the outer-edge of one of the rule marks that bounds the selected distance and then drag to the outer edge of the other rule mark that bounds the selected distance. A measurement calibration window (not shown) will appear and indicate how many pixels the mouse cross hairs moved. For example, the window could indicate that the mouse cross hairs moved 35 pixels over a distance of one mm on the ruler being utilized.

The Draw buttons 96. These buttons allow permit circles, ellipses, squares or rectangles to be drawn in window 107. These buttons can also be used to draw from the center of an object. The measurements that appear represent the x and y of the shape you draw. Holding the Shift key down while left clicking the mouse and dragging in any direction will keep the shape uniform in size. Holding the Ctrl key own while left clicking the mouse and dragging in any direction will start the shape at the middle instead of the side. This is useful when measuring holes or objects within objects. If you hold both the Shift key and the Ctrl key down together, the object will begin in the middle and remain symmetrical.

The Chroma Stain Selector button 97. Click button 97 and point to a pixel(s) to select the pixel(s) to be stained.

The Barcode button 98. This is used to setup the barcode feature. The barcode reader can be set to read various types of barcodes, either vertically, horizontally, or diagonally. There are various barcode standards available including Code formats, EAN, Interleaved, Code Bar, and UPCA. The reader can be set to take snapshots at given intervals.

The Session window 109 is the first window that opens, even if there is not a camera running. The Session window 109 is where images are saved for review.

All of the sessions and snap-shots default to the CapSure folder within the “My Pictures” folder. The default can be changed easily from within the preference menu in the Root Capture Directory (not shown).

The Preferences window (not shown) allows you to set a default name for the images, reset the name counter, select the type of compression and change the quality of the image.

To adjust Preferences:
Choose FILE in the Session Window 109 (FIG. 36).
Change Root capture Directory (not shown) if desired by clicking on Browse
Change file name by typing in Base File Name box.
Select desired file type and adjust the quality.
Click OK

Select the video source or camera:
Choose FILE in the Session Window 109 (FIG. 36).
Choose Select Source (not shown)
Select Video Capture Source window will display available cameras.
To format the camera, click on Format
   Colorspace default is set to RGB 24
   Output size will open to the largest format available from your camera.
Adjust your desired settings in the Camera Properties window (not shown)
   The format and video controls can vary from camera to camera. Many cameras have a default setting. The default setting is recommended when using the video computer program 31A.

The image displayed in the main monitoring window 107 is centered, defaults to 100% scale and 720×480 if you use a camera larger than 640×480 (VGA). Window 107 to be scaled to any size that feels comfortable or fits your computer monitor's resolution. If you double click the blue or gray header of window 107, the image in the window goes to full screen.

A session is a folder filled with a set of pictures (e.g., images) that were saved. Program 31A can—during a session—manage, name, and number images. Each time program 31A is launched, program 31A automatically opens the most recent session in session window 109. A session prior to the most recent session or a new session can be opened by clicking on FILE in session window 109 (FIG. 36).

Program 31A chooses a default session name for each session started and saves the default name in the My Pictures folder (or other location if so specified in preferences). The preferences associated with a session name can be changed by clicking on FILE in window 109 and selecting Preferences (not shown). When you close a session, program 31A automatically saves the session.

To label a video that is appearing in monitoring window 107, click “Show” 81 (FIG. 35) and then click Label Properties (not shown). Drag down to Label Properties and click—delete. A properties window will appear and ask for a name and the size of text desired. Select the optional Date and Time overlay. The default is your local time zone. The title will appear at the top of the window 107 and the time stamp at the bottom of the window 107. Both the title and time stamp are fixed at the top and bottom of the full image. If you zoom in and do not see the text and/or time stamp, the image that is visible on window 107 will be captured without the text and time if the Snap button is clicked instead of the Picture button.

Program 31A is presently preferably utilized in conjunction with an iREZ microscopy camera such as an iREZ i1300c, iREZ i2100c, iREZ KD, iREZK2, iREZ K2r, IREZ USB Live 2, and TotalExam™—each with an appropriate driver. An iREZ 1300c camera utilizes, for example, an iREZ i1300c driver.

FIGS. 11 to 25 describe a video camera 101 that can be utilized in conjunction with computer program 31A. The camera 101 is a small, handheld, high-resolution examination camera particularly intended for the medical and life science fields. Camera 101 is durable, light-weight, easy-to-use, includes a snap-shot capability and is freeze-frame ready. The camera 101, in conjunction with program 31A, can interface directly into any number of analog or digital video processing devices such as, for example, an iREZ iNspexc video compositing engine.

The block diagram 100 of FIG. 11 includes an examination video camera 101 having an optical end 105 and an interface end 103 comprising an optical sensor assembly 130 in electrical communication with a camera body 140. The camera body 140 interfaces 150 a connection 160 which can be wired, optical, or wireless. Connection 160 provides data communication and, optionally, power to and from camera 101. Optical/sensor assembly 130 includes a light producing assembly 500 (FIG. 14) which provides illumination 120. Assembly 500 is presently preferably, but not necessarily, axially aligned with a lens assembly and is positioned so as not to illuminate the lens assembly other than via light 122 reflected off target 120 and up through the lens assembly into camera 101. The lens assembly includes a lens fixedly mounted inside a hollow lens barrel (FIG. 14).

Light 122 reflected from a target 120 is received and processed by optical/sensor assembly 130, is relayed to the camera body 140, and is transmitted to a video capture and/or processing component 170. Optional attachments 180 can be mounted on the optical end of the camera body 140, and may include for example a removable hood 180 (FIG. 13), tongue depressor 1200 (FIGS. 22-25), an ultrasound sensor, or a laser sensor to measure the distance of the camera from a target. As would be appreciated by those of skill in the art an ultrasound sensor, a laser distance sensor, or other attachments need not necessarily be attached to the optical end of the camera body 140, but can be mounted at any desired location on the camera.

In the event a laser distance sensor (or sonar or other distance sensing device) is mounted on camera 101, one possible calibration technique includes the steps of (1) placing a known measurement scale in the field of view of the camera and at a selected distance from the laser distance sensor, say 50 mm; (2) examining the display screen (typically 1280×720 pixels) on which the image of the measurement scale that is generated using signals from the camera is shown; (3) determining the number of display screen pixels in a selected reference unit of measurement on the measurement scale, say one mm, (4) successively moving the camera (and therefore the laser distance sensor) incrementally closer to (or farther from) the measurement scale (while retaining the scale in the field of view of the camera) and recording the number of pixels equivalent to the selected reference unit of measurement of one mm for each distance of the laser sensor from the measurement scale, i.e., for distances of 48 mm 46 mm, 44 mm, etc., (5) generating an algorithm that indicates the number of pixels in the display screen 23 (FIG. 31) in a mm for a particular distance of the sensor from the measurement scale or from another object; and (6) using the algorithm in controller 30 and data in memory 29 (FIG. 26) to calculate a distance (in pixels) of one mm on the display screen (typically 1280×720 pixels) when the laser distance sensor (or other sensor) is a particular distance from a target. Other more accurate algorithms can, if desired, be generated by taking into consideration physical properties of the sensors, lens, etc. When the controller 30 is provided with one or more of the algorithms noted above in this paragraph, controller 30 can, if desired, cause a depiction of a measurement scale to appear on the display screen. The size of this measurement scale will vary with distance of the camera from a target. For example, when the camera is closer to a target, a distance of one mm will take up a greater number of pixels on the display screen 23 (FIG. 31). When the camera is further from a target, a distance of one mm will require a lesser number of pixels on the display screen 23. In addition to controller 30 causing a measurement scale to appear on a display screen 23, a mouse can be utilized to “click and drag” a selected distance on display screen 23 and controller 30 will, after the distance is selected, automatically label on display 23 the selected distance with the true length of the distance, e.g. arrows will appear on display 23 indicating the selected distance and the arrows will be labeled with a numerical value indicating the distance. The numerical value can be 4.5 mm, 6.789 mm, 1.000 mm, etc.—whatever comprises the true length of the selected distance. If the foregoing procedure is utilized in conjunction with a camera that has a zoom or other adjustable lens, then the distance of the camera (or sensor) from a target is also correlated with the lens setting. The “click and drag” procedure can also be utilized to measure the diameter of a circle and the diagonal of a square or other orthogonal figure, and program 31B can be provided with algorithms to calculate the circumference of a circle, the square of the diameter of a circle or of the diagonal of an orthogonal figure, etc.

In another embodiment of the invention utilized to measure the distance of a camera from a target, a transmitter unit like an RFID is provided at the point a camera contacts a target (or is provided at a point on a target when the camera is spaced apart from the target), the RFID has a particular dimension, and a receiver on the camera picks up the signal from the RFID to provide an accurate measurement without the need for calibration or of a laser or other measuring system.

An external view of camera 101 is shown in FIG. 12.

FIG. 13 is a partial exploded view of the handheld video examination camera 101, which view depicts an optional hood 180, an optical/sensor assembly 130, camera body 140 and housing 111.

In FIGS. 14 and 15, the optical sensor assembly 130 is shown in further detail and includes sensor/LED assembly 500, a head, a lens barrel, and a window. The head is shown in further detail in FIG. 20.

In FIGS. 16 and 17, LEDs 550 are mounted on LED board 520 and wires 530 each deliver electricity to an LED 550. When assembled, LED board 540 is secured adjacent spacer 520, and spacer 520 is secured adjacent sensor board 510. Sensor 515 is mounted on board 510.

In one embodiment, a lens assembly comprising one or more lenses is mounted in a light transmitting lens barrel or other housing or lens support assembly which is translucent, semi-translucent, or transparent. The light transmitting lens barrel is mounted in the optical/sensor assembly 130. Light provided by LEDS 550 in the sensor/SED assembly 500 (FIGS. 16-19) passes through the focusing barrel and illuminates the target.

LEDs 550 or another desired light source can produce visible or non-visible light having any desired wavelength, including, for example, visible colors, ultraviolet light, or infrared light. The light source can produce different wavelengths of light and permit each different wavelength to be used standing alone or in combination with one or more other wavelengths of light. The light source can permit the brightness of the light produced to be adjusted. For example, the light source can comprise 395 nM (UV), 860 nM (NIR), and white LEDs and can operated at several brightness levels such that a health care provider can switch from white light to a “woods” lamp environment at the touch of a control button on the camera 101. The light source, or desired portions thereof, can be turned on and off while camera 101 is utilized to examine a target. In some instances, it may be desirable to depend on the ambient light and to not produce light using a light source mounted in camera 101.

In the preferred embodiment of the invention illustrated in FIGS. 14 to 19, the lens barrel is opaque and the upper end of the lens barrel extends upwardly into the cylindrical opening extending through the center of spacer 520. This cylindrical opening is visible in FIG. 17. The outer diameter of the lens barrel is only slightly less than the inner diameter of the cylindrical opening formed through the center of spacer 520. Consequently, even though the upper end of the lens barrel can move in the cylindrical opening that extends through spacer 520 when the head is turned to adjust the focus of the camera, the “tight fit” between the upper end of the lens barrel and the cylindrical opening in spacer 520 effectively prevents light produced by LEDs 550 from reaching sensor 515.

The lower end of the lens barrel is fixedly secured to the window, and the window is fixedly secured to the lower end of the head. The upper end of the head is internally threaded and turns onto the lower externally threaded end of the camera body. After the head is turned onto the lower threaded end of the camera body, the position of the head can be adjusted—and the focus of the lens adjusted—by turning the head on the lower threaded end of the camera body. As noted above, however, when the focus of the lens is adjusted by turning the head, the upper end of the lens barrel remains in spacer 520 to prevent light from LEDs from passing upwardly into sensor 515. Instead, sensor 515 only detects light that is produced from LEDs 550 and is reflected from a target upwardly through the lens and into the sensor 515.

FIG. 20 illustrates a head 130A, lens barrel 130B, and window 130C.

FIG. 21 illustrates an alternate hood 1110 that can be utilized in place of the hood 180 in FIG. 13. The upper end 1120 of hood 1110 is shaped and dimensioned to be attached to the periphery of the window (FIG. 14) at the lower end of the optical/sensor assembly 130, or, is formed to attach to some other portion of the assembly 130.

The speculum 1200 illustrated in FIGS. 22 to 25 includes hollow cylindrical body 1210 and tongue 1220 connected to body 1210. Speculum 1200 can, in the same manner as a hood 180 or 1110, be attached to the periphery of the window or to some other portion of the optical/sensor assembly 130. Hood 1110, speculum 1200, and other such attachments preferably are detachably secured to camera and can, if desired, be disposed of after a selected number of uses.

In one embodiment of the invention, a hollow cylindrical body 1210 is provided standing alone and does not include tongue 1220. Instead a detent or aperture or slot is formed in body 1210 that permits one end of a tongue depressor to be removably inserted in the slot. After the tongue depressor (which looks like a popsicle stick) is utilized, it is removed from the slot and discarded and a new tongue depressor is inserted in the slot.

FIGS. 37 and 38 each illustrate a dermacollar which can be shaped and dimensioned to be secured directly the optical/sensor assembly 130 or to a hood 1110 or 180 that is mounted on assembly 130. The hollow cylindrical dermacollar 113 in FIG. 37 includes a circular groove that frictionally removably engages the distal lip of hood 1110. Similarly, the dermacollar 117 in FIG. 38 includes a circular groove 119 that removably frictionally engages the distal lip of a hood 1110. The distal lip of a hood 1110 is the lip spaced furthest away from the window of assembly 130. In FIG. 21, the distal lip of the hood is the left most lip.

The shape and dimension of the dermacollar can vary as desired. By way of example, and not limitation, the presently utilized dermacollar has a height 121 (FIG. 38) of about one centimeter.

In one preferred embodiment of the invention, a dermacollar 113, 117 is fabricated from an elastic polymer and has a durometer of about 40 to 45 such that the dermacollar is pliable and can conform to gradual curvatures of the human body or another target. The durometer of the dermacollar can, if desired, be reduced, the thickness of the collar reduced, or some other physical property(s) of the dermacollar altered to increase the ability of the dermacollar to conform to an object that is not flat. It currently is preferred to utilize a dermacollar that is—although somewhat elastic and/or pliable—substantially rigid so that the dermacollar functions as a spacer and maintains the video camera on which the dermacollar is mounted at a substantially fixed distance from a target once the dermacollar is placed in contact with the target.

The dermacollar can be opaque, but in one embodiment is preferably translucent or transparent to allow ambient light to pass through the dermacollar and contact the target. A combination of light from the camera light source (e.g., LEDs 550) and ambient light sometimes better illuminates a target than does camera light or ambient light alone.

Another desirable feature of a dermacollar 112, 117 comprises manufacturing the dermacollar such that at least the portion of the dermacollar that contacts the skin of a patient or contacts another target is somewhat “sticky” and adheres to the target to secure a camera in position once the dermacollar contacts the target. The dermacollar is “sticky” enough to engage the target and generally prevent the dermacollar from sliding laterally over the surface of the target (much like rubber feet on kitchen appliances engage a counter top to prevent the appliance from sliding over the counter top), but is not sticky enough to permanently adhere to the skin or other target. The dermacollar can be readily removed from the target in the same manner as many “non-stick” bandages and medical wraps or as rubber feet that are found on kitchen appliances.

In an alternate embodiment of the dermacollar, a removable sticky protective film is applied to the dermacollar and contacts the skin of a patient. After an examination of a patient or other target is completed, the film is peeled off the dermacollar and discarded and a new protective film is applied. The shaped and dimension of the film can vary as desired, but the film presently preferably typically consists of a flat circular piece of material that only covers the circular target—contacting edge of a dermacollar and that does not extend across and cover the hollow opening that is circumscribed by a dermacollar.

FIG. 26 illustrates a preferred embodiment of the invention which is particularly utilized in connection with medical examinations or procedures but which can be utilized in other applications. The improved video conferencing system of FIG. 26 includes a controller 30; a memory 29; a video input 24 from a camera 101 or other source; a keyboard/mouse for inputting text or commands; a local display 23 utilized in conjunction with and typically at the same location as controller 30, memory 29, keyboard 25, and video input 24; a first remote video conference system 26; and, a second remote video conference system 27. The controller 20 includes a control 34 with an operating system 21 such as, in the case of Microsoft systems, WINDOWS®. The memory 29 includes OS interface data 11, video conference interface data 28, video data from a camera or other source 15, and video manipulation data 17. The memory 29 can be any suitable prior art memory unit such as are commonly used in industrial machines, cameras, video conferencing systems, etc. For example, electromagnetic memories such as magnetic, optical, solid state, etc. or mechanical memories such as paper tape can be used. The controller 30 and memory 29 typically are embodied in a microprocessor and its associated memory devices. A computer program 31B constructed according to the invention is loaded into the controller 30. Program 31B includes an OS interface sub-routine 31, a video conference interface sub-routine 32, and a video display and manipulation sub-routine 33. The OS interface sub-routine 31 functions to interface with operating system 21 and, as noted when WINDOWS is the operating system, presently utilizes DirectX to facilitate the interface. The video conference interface sub-routine 32 functions to interface with the camera or other device providing input 24 and functions to interface with remote video conference systems 26 and 27 by producing a signal that mimics a video driver so that remote systems 26 and 27 will open the signal. The video display & manipulation sub-routine 33 processes the video input utilizing input from mouse/keyboard 25 or other data input and utilizing various controls and commands exemplified by control button menu 99.

FIG. 27 is a block flow diagram which illustrates a typical program or logic, function which is executed by the controller 30 for calculating the true size or dimension of a distance that is in the field of view of a camera 101, is accordingly therefore shown on a display screen 23 operatively associated with camera 101, and is selected on the display screen 23. The basic control program 41 consists of commands to “start and initialize” 35, “read memory” 36 and “transfer control” 37 to the size calculation sub-routine 46. The size calculation sub-routine 46 consist of commands to “interpret memory” 42 (e.g., determine the distance of the camera (or of the distance sensors) from the target, “calculate size” 43 (using an algorithm of the type earlier described herein) of the distance selected on the display screen 23 (FIG. 31), “display on screen” 44 the calculated numerical value of the selected distance, and “return to control program” 45. The size calculation sub-routine 46 is repeated (particularly is the distance from the camera to the target is changing) as indicated by the “repeat to last memory step” 38 of the control program 41 followed by an “end” program 39 which completes the execution of the program.

FIG. 28 is a block flow diagram which illustrates another typical program or logic function which is executed by the controller 30 for applying a color to a selected area of an image that is in the field of view of a camera 101 and is shown on a display screen 23. The basic control program 41 consists of commands to “start and initialize” 35, “read memory” 36 and “transfer control” 37 to the application of color sub-routine 52. The application of color sub-routine 52 consists of commands to “interpret memory” 47 (e.g., determine area to be colored and the selected color), “digitally apply color selected to selected area” 48, “display on screen” 49 the selected color in the selected area, and “return to control program” 51. The size calculation sub-routine 52 is repeated as desired as indicated by the “repeat to last memory step” 38 of the control program 41 followed by an “end” program 39 which completes the execution of the program.

FIG. 29 is a block flow diagram which illustrates another typical program or logic function which is executed by the controller 30 for correlating color with movement of an amoeba or other selected object that is in the field of view of a camera. The basic control program 41 consists of commands to “start and initialize” 35, “read memory” 43 and “transfer control” 37 to the correlation of color with movement sub-routine 56. The correlation of color with movement sub-routine 56 consist of commands to “interpret memory” 53 (e.g., determine the new location of amoeba), “digitally apply color to pixels on screen that define amoeba at new location” 54, and “return to control program” 55. The correlation of color with movement sub-routine 56 is repeated as indicated by the “repeat to last memory step” 38 of the control program 41 followed by an “end” program 39 which completes the execution of the program.

The following prophetic example is given by way of illustration, and not limitation, of the invention.

### EXAMPLE

A beautiful, highly-paid, articulate, Oscar-winning Hollywood actress has been given a role in a movie that has been predicted to receive several Oscar® nominations. The movie is scheduled to begin production in only three weeks, on December 31. Apart from her intellect, athletic ability, and her well-documented superb acting abilities in a wide range of roles, the actress has also achieved frame for her legs. The upcoming movie will showcase her legs in several scenes.

There are three moles on the front thigh of the right leg of the actress. At least one of the moles may have changed appearance over the last several months. The actress has been urged by her husband and other business associates to have the moles checked, but she has put off such examination in part because of her busy schedule and in part because, as she puts it, “I have little patience for doctors and lawyers! The term ‘professional’ does not apply to many of those people!”.

The right leg of the actress is illustrated in FIG. 30 and includes thigh 59 with outer side or surface 57, femur 58, and moles 62, 63, 69.

Now, with shooting of the movie to begin in three weeks, the actress has finally consented to an examination. As is depicted in FIG. 31, three physicians are involved simultaneously in the examination. The first, a dermatologist 64, has brought a digital video camera 61 comparable to camera 101 to the residence of the actress, and, has also brought along a laptop computer and a microphone/speaker. The laptop computer includes display screen 23. The laptop computer utilizes the WINDOWS® operating system. A video conferencing application (i.e., software/computer program) (or web conferencing application or other collaboration application) is loaded on the laptop computer, along with video interface, display, and manipulation application (i.e., software/computer program) 31B (FIG. 26) that interfaces with the video camera 61, with the WINDOWS operating system, with the video conferencing application, and with video conferencing applications in each of the two remote videoconferencing systems 26 and 27 described below. The video conferencing application on the laptop computer could, by way of example, comprise the POLYCOM PVX™ or POLYCOM VIAVIDEO LIVE™ applications shown in FIG. 10. Application 31B receives from digital video camera 61 a signal comprising a digital video image and produces a video conference interface signal that presents itself as a video source to the video conferencing application in the laptop computer. The video conferencing application in the laptop computer then transmits to the video conferencing applications in systems 26 and 27 a digital video signal comprising a digital video image. The video conferencing applications in system 26 and 27 receive the transmitted digital video signals and cause the digital video image to appear on display screens 65 and 67, respectively. Systems 26 and 27 are at separate locations. The video camera 61 is equipped with an ultrasound sensor or other sensor system that detects bones and organs. The dermatologist's laptop includes software that will display bones and organs in outline or ghost image on the laptop screen 23 along with the exterior of the target viewed by camera 61. The dermatologist finds it useful to be able to ascertain the location of bones and organs in connection with surface skin infections or injuries. The video camera 61 is also equipped with laser sensors that determine the distance of camera 61 (or of the sensors) from a target such that software 31B can calculate the true size of a target, or portion thereof, viewed by camera 61 based on the distance of camera 61 from the target.

The first remote video conferencing system 26 includes, along with the video conferencing application noted above, a computer/speaker and a display screen 65 and is located in the office of a pathologist 66.

The second remote video conferencing system 27 includes, along with the video conferencing application noted above, a computer/speaker and a display screen 67 and is located in the office of the well known cosmetic surgeon 68 on whom the actress relies.

In the event removal of any of the moles is required, the actress would like her recovery completed by the time production of the movie begins.

Video conferencing signals are transmitted from the video conferencing application in the dermatologist's laptop to the video conferencing application in each of the remote systems 26, 27 via the Internet, satellite, telephone lines, or any other desired signal and data transmission system.

In FIG. 31, the dermatologist is holding the camera 61 approximately a foot and a half from the front of the thigh 59 of the actress. Moles 62, 63, 69 are visible on screen 23, along with an outline of the femur 68. Software 31B transmits the image appearing on screen 23 to the remote video conferencing system 26 and 27 so that the pathologist 66 and cosmetic surgeon 68 view simultaneously on their respective display screen 65 and 67 the image that is within the field of view of camera 61 and that is also shown at the same time on display screen 23. The pathologist 66 and cosmetic surgeon 68 audibly confirm to the dermatologist 64 that they are receiving and viewing a signal showing the thigh of the actress along with the three moles on the front of the thigh. The pathologist requests that the video camera be moved closer to the target to produce on screens 23, 65, 67 the images illustrated in FIG. 32. The dermatologist complies. The dermatologist 64 also with his mouse “clicks and drags” a distance across each of the moles. Program 31B calculates the true size of each mole and causes, a numerical value identifying the distance across the mole to be displayed on each of the display screens 23, 65, 67. Program 31B also causes, as shown in FIG. 32, lines that indicate the distance across each mole to appear on each display screen in conjunction with said numerical values.

In FIG. 32, the bolded “8” on screen 23 (and screens 65 and 67) indicates that mole 63 is eight mm wide; the bolded “4s” indicate that moles 62 and 69 are each four mm wide. The pathologist 66 and dermatologist note that most normal moles are only five or six mm wide, and that the greater-than-normal width of mole 63 suggests that it may be a melanoma. Further, the pathologist 66 notes that most normal moles are symmetrical, or round, and that the irregular shape of mole 63 further suggests that it may be a melanoma.

In FIGS. 31 to 34 display screens 23 and 65 simultaneously display the same picture or image, as do display screens 23 and 67. It is possible for the computer utilized by dermatologist 64 to manipulate the image on screen 23 independently of the image shown on screens 65 and 67, in which case screens 65 and 67 continue to display what is being viewed by camera 61.

The pathologist 66 requests that camera 61 be moved closer yet to the moles, or that the camera lens be adjusted to magnify the moles. The dermatologist complies and the displays shown on screens 23, 65, 67 appear as shown in FIG. 33. The dermatologist 64 notes that the variation in coloration of mole 63 further suggests that it is a melanoma, and recommends that mole 63 be removed immediately. The actress asks for the estimated recovery time.

The pathologist 66 and cosmetic surgeon 68 ask the dermatologist 64 to maneuver camera 61 such that it views the thigh of the actress from the side in the manner indicated by arrow A in FIG. 30. The dermatologist complies. The displays that appear on screens 23, 65, 67 are shown in FIG. 34. The ultrasound sensor on camera 61 detects that mole 63 has begun to grow and, consequently, includes a base 73 that extends a short distance into the dermis. Fortunately, the base 73 does not appear to have penetrated a distance sufficient for metastasis to have occurred. The cosmetic surgeon 68 estimates that if the surgery is carried out immediately, the resulting wound should be substantially superficial and there is a good chance that the wound will have healed prior to the beginning of production of the movie and that scar tissue can be minimized and eventually substantially eliminated.

The actress wishes to retain moles 62 and 69 and asks if the incision required to remove mole 63 will remove either of moles 62 and 69. The plastic surgeon notes that mole 63 is closer to mole 62 than mole 69; that base 73 does not appear to have spread outside the perimeter of the surface portion of mole 63; that it initially appears that both moles can be spared; that melanoma is a serious disease; and, that the final determination will depend on what is found during the removal of mole 63. The plastic surgeon notes that as can be seen on display screens 23, 65, 67 moles 62 is only about four to five mm from mole 63, while mole 89 is about eight mm from mole 63.

The dermatologist 64 utilizes his mouse to direct software 31B to draw a circle around, centered on, and spaced apart from mole 63 to indicate a proposed incision line. Software 31B causes the proposed incision line to instantly simultaneously appear on displays 23, 65, 67. The diameter of the circle is ten mm. The dermatologist asks the pathologist 66 and cosmetic surgeon 68 if it is likely that such an incision would capture all cancerous cells that likely are associated with mole 63. Both the pathologist 66 and surgeon 68 indicate that such an incision likely would capture all cancerous cells if such cells were, as indicated in FIG. 34, within the perimeter of the visible outer portion of mole 63, but that an incision diameter of about twelve millimeter would produce a much higher confidence level and still likely permit the actress to retain moles 62 and 69. Instead of having software 31B draw a circle in the manner noted above, the dermatologist 64 could have drawn the proposed incision line directly on the skin of the leg of the actress. The line, when drawn, would have been instantly simultaneously been visible on displays 23, 65, 67.

1. A method of generating a digital video image of a patient at a first location and simultaneously transmitting the video image to a video conferencing system at a second location remote from the first location, comprising the steps of:
(a) providing at a first location a video conferencing system including a display screen, a computer, a microphone/speaker, and a first video conferencing application on said computer;
(b) providing at a second location remote from said first location
(i) a computer system with a WINDOWs operating system, a controller, a system memory, and a display screen
(ii) a digital video camera operatively associated with said computer system to produce a digital video signal of at least a portion of the patient's body,
(iii) a second video conferencing application in said computer system to transmit to said first video conferencing application a digital video signal comprising a digital video image,
(iv) a computer program in said computer system to
interface with said operating system,
interface with said video camera,
interface with said second video conferencing application by producing a video conference interface signal that
presents itself as a video source to said second video conferencing application,
comprises a digital video image produced from said digital video signal of said video camera, and
can be opened by said second video conferencing application in said computer system to transmit to said first video conferencing application a digital video signal comprising a digital video image;
(c) utilizing said digital video camera to produce a primary digital video signal comprising a primary digital video image of a portion of the patient's body during a medical procedure; and,
(d) processing said primary digital video signal with said computer system and said computer program at said second location to
(i) produce for said second video conferencing application a video conference interface signal of said primary digital video signal,
(ii) transmit to said first video conferencing application with said second video conferencing application a digital video signal of said primary digital video signal such that said primary digital image is produced on said display screen at said first location simultaneously with said production of said primary digital video image on said display screen at said second location.

2. A method of generating a digital video image of a patient at a first location and simultaneously transmitting the video image to a video conferencing system at a second location remote from the first location, comprising the steps of:
(a) providing at a first location a video conferencing system including a display screen, a computer, a microphone/speaker, and a first video conferencing application on said computer;
(b) providing at a second location remote from said first location
(i) a computer system with a WINDOWs operating system, a controller, a system memory, and a display screen
(ii) a digital video camera operatively associated with said computer system to produce a digital video signal of at least a portion of the patient's body, said signal including data defining the distance of said digital video camera from the patient's body,
(iii) a second video conferencing application in said computer system to transmit to said first video conferencing application a digital video signal comprising a digital video image,
(iv) a computer program in said computer system to
interface with said operating system,
interface with said video camera,
interface with said second video conferencing application by producing a video conference interface signal that
presents itself as a video source to said second video conferencing application,
comprises a digital video image produced from said digital video signal of said video camera,
can be opened by said second video conferencing application in said computer system to transmit to said first video conferencing application a digital video signal comprising a digital video image, and
utilize said distance included in said video signal to determine the true size of at least a portion of said video image;
(c) utilizing said digital video camera to produce a primary digital video signal comprising a primary digital video image of a portion of the patient's body during a medical procedure; and,
(d) processing said primary digital video signal with said computer system and said computer program at said second location to
(i) produce for said second video conferencing application a video conference interface signal of said primary digital video signal,
(ii) determine the true size of at least a portion of said digital video image, and
(iii) transmit to said first video conferencing application with said second video conferencing application a digital video signal of said primary digital video signal such that said primary digital image is produced on said display screen at said first location simultaneously with said production of said primary digital video image on said display screen at said second location.

3. A method of generating a digital video image of a patient at a first location and simultaneously transmitting the video image to a video conferencing system at a second location remote from the first location, comprising the steps of:
(a) providing at a first location a video conferencing system including a display screen, a computer, a microphone/speaker, and a first video conferencing application on said computer;
(b) providing at a second location remote from said first location
(i) a computer system with a WINDOWs operating system, a controller, a system memory, and a display screen
(ii) a digital video camera operatively associated with said computer system to produce a digital video signal of at least a portion of the patient's body, said camera including a lens,
(iii) a dermacollar attached to said video camera and extending outwardly away from said lens to
contact the patient,
conform at least in part to the patient's body, and
maintain said lens at a substantially fixed distance from the patient's body,
(iv) a second video conferencing application in said computer system to transmit to said first video conferencing application a digital video signal comprising a digital video image,
(v) a computer program in said computer system to
interface with said operating system,
interface with said video camera,
interface with said second video conferencing application by producing a video conference interface signal that
presents itself as a video source to said second video conferencing application,
comprises a digital video image produced from said digital video signal of said video camera, and
can be opened by said second video conferencing application in said computer system to transmit to said first video conferencing application a digital video signal comprising a digital video image;
(c) placing said dermacollar against a portion of the patient's body such that said dermacollar conforms at least in part to the patient's body and generally maintains said lens at a fixed distance from the patient's body;
(d) utilizing said digital video camera to produce a primary digital video signal comprising a primary digital video image of a portion of the patient's body during a medical procedure; and,
(e) processing said primary digital video signal with said computer system and said computer program at said second location to.
(i) produce for said second video conferencing application a video conference interface signal of said primary digital video signal,
(ii) transmit to said first video conferencing application with said second video conferencing application a digital video signal of said primary digital video signal such that said primary digital image is produced on said display screen at said first location simultaneously with said production of said primary digital video image on said display screen at said second location.

4. A method of generating a digital video image of a patient at a first location and simultaneously transmitting the video image to a video conferencing system at a second location remote from the first location, comprising the steps of:
(a) providing at a first location a video conferencing system including a display screen, a computer, a microphone/speaker, and a first video conferencing application on said computer;
(b) providing at a second location remote from said first location
(i) a computer system with a WINDOWs operating system, a controller, a system memory, and a display screen
(ii) a digital video camera operatively associated with said computer system to produce a digital video signal of at least a portion of the patient's body, said camera including a lens, said signal including data defining the distance of said camera from the patient's body,
(iii) a dermacollar attached to said video camera and extending outwardly away from said lens to
contact the patient,
conform at least in part to the patient's body, and
maintain said lens at a substantially fixed distance from the patient's body,
(iv) a second video conferencing application in said computer system to transmit to said first video conferencing application a digital video signal comprising a digital video image,
(v) a computer program in said computer system to
interface with said operating system,
interface with said video camera,
interface with said second video conferencing application by
producing a video conference interface signal that
presents itself as a video source to said second video conferencing application,
comprises a digital video image produced from said digital video signal of said video camera, and
can be opened by said second video conferencing application in said computer system to transmit to said first video conferencing application a digital video signal comprising a digital video image,
Utilize said distance included in said video signal to determine the true size of at least a portion of said video image;
(c) placing said dermacollar against a portion of the patient's body such that said dermacollar conforms at least in part to the patient's body and generally maintains said lens at a fixed distance from the patient's body;
(d) utilizing said digital video camera to produce a primary digital video signal comprising a primary digital video image of a portion of the patient's body during a medical procedure; and,
(e) processing said primary digital video signal with said computer system and said computer program at said second location to
(i) produce for said second video conferencing application a video conference interface signal of said primary digital video signal,
(ii) transmit to said first video conferencing application with said second video conferencing application a digital video signal of said primary digital video signal such that said primary digital image is produced on said display screen at said first location simultaneously with said production of said primary digital video image on said display screen at said second location.
